(19) United States
(12) Patent Application Publication
(10) Pub. No.: US 2026/0336516 A1
(43) Pub. Date: Oct. 29, 2026

(54) TOWING-TRIGGERED VISIBILITY COMPLIANCE INDICATORS

(71) Applicant: Volvo Car Corporation, Göteborg (SE)

(72) Inventors: Magnus Axelsson, Mölnlycke (SE); Fredrik Niklasson, Gothenburg (SE); Anders Johansson, Kungsbacka (SE)

(21) Appl. No.: 19/187,440

(22) Filed: Apr. 23, 2025

(51) Int. Cl. B60R 1/07; B60K 35/22; B60K 35/28; B60R 1/26; G06Q 50/26; G06V 10/82; G06V 20/56; B60D 1/58

(52) U.S. Cl. CPC B60R 1/07; B60K 35/22; B60K 35/28; B60R 1/26; G06Q 50/26; G06V 10/82; G06V 20/56; B60D 1/58; B60K 2360/1523; B60K 2360/178

(57) ABSTRACT

Systems/techniques that facilitate towing-triggered visibility compliance indicators are provided. In various embodiments, a system can be onboard a vehicle. In various aspects, the system can access, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle. In various instances, the system can render a first warning on a console display of the vehicle, in response to a determination that the width of the side-view mirror does not provide a threshold amount of rearward visibility given the geometric dimensions of the vehicle and the geometric dimensions of the trailer.

### TECHNICAL FIELD

The subject disclosure relates generally to vehicular towing, and more specifically to towing-triggered visibility compliance indicators.

### BACKGROUND

Towing a trailer with insufficient rearward visibility is extremely unsafe.

Accordingly, systems or techniques that can address such extreme unsafety can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate towing-triggered visibility compliance indicators are described.

According to one or more embodiments, a system is provided. The system can be onboard a vehicle, and the system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a metadata component that can access, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle. In various instances, the computer-executable components can comprise a compliance component that can render a first warning on a console display of the vehicle, in response to a determination that the width of the side-view mirror does not provide a threshold amount of rearward visibility given the geometric dimensions of the vehicle and the geometric dimensions of the trailer.

According to one or more embodiments, the above-described system can be reformulated as a computer-implemented method or computer program product.

### DESCRIPTION OF THE DRAWINGS

FIG. 1 illustrates an example, non-limiting block diagram showing a rearward visual field of a vehicle towing a trailer in accordance with one or more embodiments described herein.

FIG. 2 illustrates a block diagram of an example, non-limiting system that facilitates towing-triggered visibility compliance indicators in accordance with one or more embodiments described herein.

FIG. 3 illustrates a block diagram of an example, non-limiting system including a hitch sensor and a towing determination indicator that facilitates towing-triggered visibility compliance indicators in accordance with one or more embodiments described herein.

FIG. 4 illustrates a block diagram of an example, non-limiting system including a geolocation sensor and a towing regulation that facilitates towing-triggered visibility compliance indicators in accordance with one or more embodiments described herein.

FIG. 5 illustrates an example, non-limiting block diagram of a location-regulation database and a towing regulation in accordance with one or more embodiments described herein.

FIG. 6 illustrates a block diagram of an example, non-limiting system including a trailer data packet and a vehicle data packet that facilitates towing-triggered visibility compliance indicators in accordance with one or more embodiments described herein.

FIG. 7 illustrates an example, non-limiting block diagram of a trailer data packet and a vehicle data packet in accordance with one or more embodiments described herein.

FIG. 8 illustrates a block diagram of an example, non-limiting system including a set of towing compliance checks and a towing compliance warning that facilitates towing-triggered visibility compliance indicators in accordance with one or more embodiments described herein.

FIG. 9 illustrates an example, non-limiting block diagram of a set of towing compliance checks in accordance with one or more embodiments described herein.

FIG. 10 illustrates a block diagram of an example, non-limiting system including a rearward image, a cargo obstruction classifier, and a cargo obstruction indicator that facilitates towing-triggered visibility compliance indicators in accordance with one or more embodiments described herein.

FIG. 11 illustrates an example, non-limiting block diagram showing how a cargo obstruction indicator can be produced by a cargo obstruction classifier in accordance with one or more embodiments described herein.

FIG. 12 illustrates an example, non-limiting block diagram showing how a cargo obstruction classifier can be trained in accordance with one or more embodiments described herein.

FIGS. 13-15 illustrate flow diagrams of example, non-limiting computer-implemented methods that facilitate towing-triggered visibility compliance indicators in accordance with one or more embodiments described herein.

FIG. 16 illustrates a block diagram of an example, non-limiting operating environment in which one or more embodiments described herein can be facilitated.

FIG. 17 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Vehicles (e.g., passenger vehicles such as sedans, sport utility vehicles, or pickup trucks; commercial vehicles such as dump trucks or semi-trucks) are often used to tow trailers in order to transport cargo (e.g., furniture, other vehicles, construction materials, or refuse). When a vehicle tows a trailer, the trailer might or might not interfere with a rearward visibility of a driver of the vehicle. In other words, the trailer or its cargo might visually obstruct, obscure, or block whatever rear-facing visual field that the driver can see in a rear-view mirror or side-view mirrors of the vehicle. In many jurisdictions, the allowable extent of such visual obstruction is explicitly regulated. Towing a trailer with a rearward visibility that is in violation of such a regulation can be extremely unsafe (e.g., can significantly increase the risk or likelihood of causing a vehicular collision, crash, or accident).

Accordingly, systems or techniques that can ameliorate such unsafety can be desirable.

Various embodiments described herein can include systems, computer-implemented methods, apparatus, or computer program products that can facilitate towing-triggered visibility compliance indicators. In particular, when a vehicle is towing a trailer, various embodiments described herein can automatically render on a screen, dashboard, or console of the vehicle an electronic notification that indicates whether or not the trailer inappropriately interferes with or blocks a rearward visibility of the vehicle. In some cases, various embodiments described herein can determine or detect such visibility interference or blockage by geometrically analyzing dimensions of the vehicle and dimensions of the trailer. In other cases, various embodiments described herein can determine or detect such visibility interference or blockage by executing a machine learning classifier on images of the trailer captured by rear-facing cameras of the vehicle. In response to determining that the rearward visibility of the vehicle is inappropriately impacted by the trailer, various embodiments described herein can involve initiating any suitable remedial actions to resolve such interference, such as automatically extending the side-view mirrors of the vehicle or recommending that the side-view mirrors be outfitted with external attachments to expand visibility. In any of such situations, such determination or detection of rearward visibility interference can be performed in response to the trailer being physically hitched to the vehicle. Accordingly, various embodiments described herein can be considered as warning in real-time a driver of the vehicle that the trailer cannot be safely towed. In some aspects, various embodiments described herein can even electronically or mechanically disable the vehicle when the trailer cannot be safely towed. In any case, various embodiments described herein can be considered as reducing the likelihood that trailers will be towed with unsafe or insufficient rearward visibilities, which can be considered as advantageous or beneficial.

Various embodiments described herein can be considered as a computerized tool (e.g., any suitable combination of computer-executable hardware or computer-executable software) that can facilitate towing-triggered visibility compliance indicators. In various aspects, the computerized tool can be hosted on a vehicle and can include a towing component, a regulation component, a metadata component, a compliance component, or a vision component.

In various embodiments, the towing component of the computerized tool can electronically determine whether or not a trailer is coupled to a hitch (e.g., ball-hitch) of the vehicle. In various aspects, the towing component can accomplish this determination via any suitable electronic sensor (e.g., strain gauge, pressure transducer, continuity sensor) that monitors the hitch.

In various embodiments, the regulation component of the computerized tool can, in response to the towing component determining that the trailer is hitched to the vehicle, electronically identify a towing regulation that is applicable to the vehicle. In various aspects, the regulation component can accomplish such determination via any suitable geolocation sensor of the vehicle (e.g., different towing regulations can apply in different geolocations). In any case, the towing regulation can specify or otherwise represent a maximum distance behind the trailer that is legally permitted to be invisible to a driver of the vehicle. Such maximum distance can alternatively be referred to as a minimum rearward visibility (e.g., the more distance behind the trailer that is invisible to the driver, the less total rearward visibility the driver has; conversely, the less distance behind the trailer that is invisible to the driver, the more total rearward visibility the driver has).

In various embodiments, the metadata component of the computerized tool can, in response to the towing component determining that the trailer is hitched to the vehicle, electronically receive, retrieve, or otherwise access a first data packet and a second data packet. In various aspects, the first data packet can be broadcast from any suitable electronic transmitter onboard the trailer and can specify, indicate, or otherwise represent geometric dimensions of the trailer. In various instances, the second data packet can be stored within any suitable electronic memory that is onboard the vehicle and can specify, indicate, or otherwise represent geometric dimensions of the vehicle and of the side-view mirrors of the vehicle.

In various embodiments, the compliance component of the computerized tool can electronically determine whether or not the minimum rearward visibility is provided or accomplished by the geometric dimensions of the trailer, of the vehicle, and of the side-view mirrors of the vehicle. Indeed, the compliance component can use the geometric dimensions of the trailer, of the vehicle, and of the side-view mirrors to triangulate a farthest blind-spot behind the trailer. Specifically, the lengths of the trailer and the vehicle and be specified in the first and second data packets, and the widths of the vehicle and its side-view mirrors can be specified in the second data packet. Thus, a respective line-of-sight can be extended backwards from each side-view mirror, such that those two lines-of-sight intersect with each other as close as possible to the trailer but without intersecting the trailer itself. That point of intersection can be considered as the farthest blind-spot behind the trailer. If the farthest blind-spot is separated from the trailer by a distance that is greater than that defining the minimum rearward visibility, the vehicle can be considered as being incapable of towing the trailer in compliance with the towing regulation. In such situation, the compliance component can: render on an electronic screen of the vehicle a warning specifying such incapability and recommending that external visibility attachments (e.g., extended mirrors, camera screens) be added to the side-view mirrors; or can electronically disable the vehicle (e.g., force a transmission of the vehicle to shift into park, force brakes of the vehicle to engage, force an engine or motor of the vehicle to power off).

Note that, if the geometric dimensions of the trailer, of the vehicle, and of the side-view mirrors do cause the farthest blind-spot to be separated from the trailer by a distance that is less than or equal to that defining the minimum required visibility, it can be concluded merely that the vehicle is capable of towing the trailer in compliance with the towing regulation; it cannot be concluded that the vehicle is actually towing the trailer is compliance with the towing regulation. After all, it can nevertheless be possible that cargo that is loaded onto the trailer protrudes laterally away from the trailer. In such situation, the protruding cargo can be considered as impermissibly obstructing the rearward visibility of the vehicle, even though the trailer itself does not impermissibly obstruct such visibility. In various embodiments, the vision component of the computerized tool can electronically detect the presence or absence of such cargo-caused visibility obstruction, by a rear-facing camera of the vehicle and by leveraging deep learning.

In particular, the rear-facing camera can be any suitable image-capture device that is physically affixed to the vehicle and that looks rearward from the vehicle toward the trailer (e.g., the rear-facing camera can be a bumper-mounted camera or a side-view-mirror-mounted camera). In various aspects, the rear-facing camera can capture an image depicting the trailer and any cargo that the trailer might be carrying from the rear-looking perspective or viewpoint of the vehicle. Accordingly, such image can be referred to as a rearward image.

Moreover, the vision component can electronically store, maintain, control, or otherwise access a deep learning neural network. In various instances, the deep learning neural network can exhibit any suitable internal architecture. For example, the deep learning neural network can include any suitable numbers of any suitable types of layers (e.g., input layer, one or more hidden layers, output layer, any of which can be convolutional layers, dense layers, long short-term memory (LSTM) layers, non-linearity layers, pooling layers, batch normalization layers, or padding layers). As another example, the deep learning neural network can include any suitable numbers of neurons in various layers (e.g., different layers can have the same or different numbers of neurons as each other). As yet another example, the deep learning neural network can include any suitable activation functions (e.g., softmax, sigmoid, hyperbolic tangent, rectified linear unit) in various neurons (e.g., different neurons can have the same or different activation functions as each other). As still another example, the deep learning neural network can include any suitable interneuron connections or interlayer connections (e.g., forward connections, skip connections, recurrent connections).

In any case, the deep learning neural network can be configured as an image classifier that can binarily classify inputted images as either depicting excessively protruding trailer cargo or not depicting excessively protruding trailer cargo. Accordingly, in various aspects, the vision component can electronically execute the deep learning neural network on the rearward image, and such execution can cause the deep learning neural network to generate a classification label. For example, the vision component can feed the rearward image to an input layer of the deep learning neural network, the rearward image can complete a forward pass through one or more hidden layers of the deep learning neural network, and an output layer of the deep learning neural network can compute the classification label based on activations generated by the one or more hidden layers during the forward pass. In some instances, the rearward image can be concatenated with the minimum rearward visibility prior to being fed to the deep learning neural network. In such situation, the minimum rearward visibility can be considered as providing additional contextual information that the deep learning neural network can leverage to help increase an accuracy of the classification label. In any case, the classification label can binarily or dichotomously indicate whether or not the rearward image depicts excessively protruding trailer cargo. In other words, the deep learning neural network can visually recognize whether or not the rearward image illustrates cargo that appears or looks to be sticking laterally or sideways out from the trailer such that the cargo impedes or blocks the minimum rearward visibility.

In response to the classification label indicating that the cargo does protrude excessively, the compliance component can: render on the electronic screen of the vehicle a warning specifying that the cargo protrudes sideways too much; or can electronically disable the vehicle.

In any case, the computerized tool can be considered as automatically detecting and helping to prevent situations in which the vehicle tows the trailer with insufficient or unsafe rearward visibility.

Various embodiments described herein can be employed to use hardware or software to solve problems that are highly technical in nature (e.g., to facilitate towing-triggered visibility compliance indicators), that are not abstract and that cannot be performed as a set of mental acts by a human. Further, some of the processes performed can be performed by a specialized computer (e.g., a deep learning neural network having internal parameters such as convolutional kernels) for carrying out defined tasks related to towing-triggered visibility compliance indicators.

For example, such defined tasks can include: accessing, by the device and in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and rendering, by the device, a first warning on a console display of the vehicle, in response to a determination that the width of the side-view mirror does not provide a threshold amount of rearward visibility given the geometric dimensions of the vehicle and the geometric dimensions of the trailer. In some aspects, the threshold amount of rearward visibility can be specified by a towing visibility regulation, which can be identified based on a current geographical location of the vehicle as measured by a global positioning sensor of the vehicle. In some instances, such defined acts can include: determining, by the device, that the trailer is hitched to the vehicle, based on a sensor monitoring a hitch of the vehicle. In some cases, such defined acts can include: recording, by the device and via a rear-facing camera of the vehicle and in response to a determination that the width of the side-view mirror provides the threshold amount of rearward visibility, at least one image depicting the trailer and a cargo of the trailer; determining, by the device and via execution of a deep learning neural network on the at least one image, whether the cargo obstructs the threshold amount of rearward visibility; and rendering, by the device and in response to a determination that the cargo obstructs the threshold amount of rearward visibility, a second warning on the console display, the second warning recommending that the cargo should be re-arranged so as to not obstruct the threshold amount of rearward visibility.

Such defined acts are inherently computerized. Indeed, vehicles, trailers, and the electrical, mechanical, or optical sensors that can be affixed to them are highly-technical computerized devices made up of specific physical hardware (e.g., drive train, axles, ball hitch, side-view mirrors, pressure transducer, global positioning sensor, bumper-mounted cameras). Neither vehicles, the trailers they tow, nor the electromechanical sensors they are equipped with can be implemented by the human mind, or by a human with mere pen and paper, in any reasonable or practicable way without computers. Additionally, machine learning models (e.g., artificial neural networks) are also inherently computerized constructs comprising specific software-oriented architectures (e.g., input layers, hidden layers, or output layers, any of which can be made up of trainable or non-trainable internal parameters such as convolutional layers or LSTM layers). Machine learning models cannot be trained or executed by the human mind, or by humans with mere pen and paper, in any reasonable or practicable way without computers.

Moreover, various embodiments described herein can integrate into a practical application various teachings relating to vehicular towing. As explained above, various jurisdictions can regulate how much rearward visibility is required for a given vehicle when towing a given trailer. Towing the given trailer with the given vehicle using less than a minimum required rearward visibility (e.g., while having a rear blind-spot that is too large) can be extremely unsafe (e.g., can materially increase the likelihood of a vehicular collision occurring).

Various embodiments described herein can address or ameliorate such unsafety. Specifically, various embodiments described herein can involve outfitting a vehicle with a computerized tool, where such computerized tool can: automatically detect whether or not the vehicle is towing a trailer; and automatically determine, in response to detection of the vehicle towing the trailer, whether or not the trailer is being towed in compliance with an applicable towing visibility regulation. The computerized tool can detect towing via any suitable electronic sensors affixed to a hitch of the vehicle, and the computerized tool can determine compliance with the applicable towing visibility regulation by analyzing geometric dimensions of the vehicle and the trailer or by analyzing an image of the trailer as seen from the rear-facing perspective of the vehicle. If the applicable towing regulation is satisfied, the computerized tool can permit such towing to proceed. However, if the applicable towing regulation is not satisfied, the computerized tool can initiate any suitable electronic actions, such as: automatically extending side-view mirrors of the vehicle; automatically recommending that side-view mirror attachments or extensions be obtained; or automatically disabling the vehicle so as to prevent the vehicle from towing the trailer. In any of such situations, the computerized tool can be considered as an electronic safety system (analogous to an anti-lock braking system or an electronic stability control system) that helps to ensure that the vehicle does not engage in trailer towing without sufficient rearward visibility, thereby significantly decreasing the likelihood or probability of towing-related accidents, collisions, or deaths. Thus, various embodiments described herein certainly constitute a concrete and tangible technical improvement in the field of vehicular towing. Therefore, various embodiments described herein clearly qualify as useful and practical applications of computers.

Furthermore, various embodiments described herein can control real-world tangible devices based on the disclosed teachings. For example, various embodiments described herein can electronically leverage real-world vehicle sensors (e.g., real-world vehicle cameras, real-world pressure transducers), can electronically execute (or train) real-world deep learning neural networks on vehicular images, and can electronically activate or deactivate real-world vehicular hardware (e.g., brakes, engines, motors).

It should be appreciated that the herein figures and description provide non-limiting examples of various embodiments and are not necessarily drawn to scale.

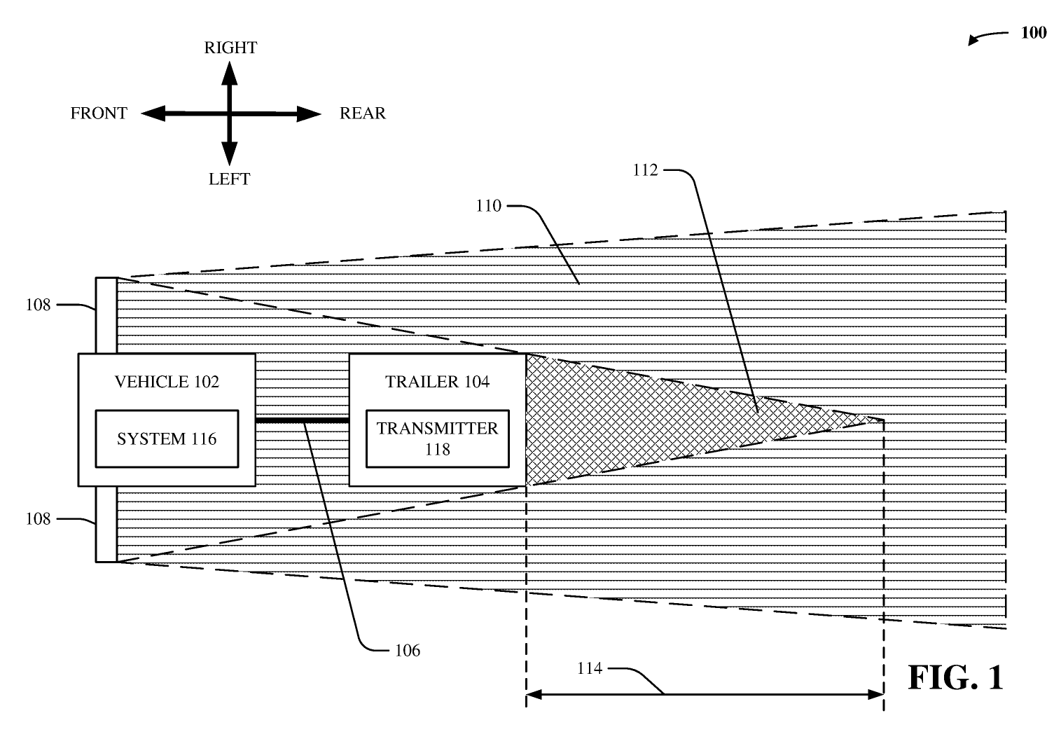

FIG. 1 illustrates an example, non-limiting block diagram 100 showing a rearward visual field of a vehicle towing a trailer, where such vehicle can facilitate towing-triggered visibility compliance indicators in accordance with one or more embodiments described herein.

In various embodiments, there can be a vehicle 102. In various aspects, the vehicle 102 can be any suitable type of automobile that can carry a driver or one or more passengers. As some non-limiting examples, the vehicle 102 can be any suitable type of car, any suitable type of truck, any suitable type of van, any suitable type of bus, or any suitable type of motorcycle. In various instances, the vehicle 102 can have any suitable type of propulsion system. As a non-limiting example, the vehicle 102 can be propelled via any suitable type of petroleum internal combustion engine. As another non-limiting example, the vehicle 102 can be propelled via any suitable type of diesel internal combustion engine. As yet another non-limiting example, the vehicle 102 can be propelled via any suitable type of electric motor. As even another non-limiting example, the vehicle 102 can be propelled in hybrid fashion via an internal combustion engine that works in concert with an electric motor.

In various cases, there can be a trailer 104. In various aspects, the trailer 104 can be any suitable type of wheeled platform or container that is designed to be towed behind a vehicle. As some non-limiting examples, the trailer 104 can be any suitable type of flatbed trailer, any suitable type of enclosed box trailer, any suitable type of refrigerated trailer, any suitable type of tanker trailer, or any suitable type of utility trailer. In various instances, the trailer 104 can carry, haul, or otherwise be designed to physically transport any suitable type of cargo or freight. As some non-limiting examples, such cargo or freight can be any suitable of furniture (e.g., couches, tables, chairs, bed frames, dressers), any suitable type of other vehicle (e.g., car, truck, all-terrain vehicle (ATV), boat), any suitable type of equipment or tools (e.g., weed whackers, lawn mowers, rakes, shovels), any suitable type of livestock (e.g., horses, pigs, chickens), any suitable type of animal feed (e.g., hay bales, grain barrels, seed sacks) any suitable type of fluid (e.g., gasoline, natural gas, oil, water), any suitable type of raw building or landscaping materials (e.g., steel stock, wooden beams or planks, wire spools, cement, stone, mulch, dirt), or any suitable type of refuse (e.g., garbage, scrap metal, scrap wood).

In various aspects, the vehicle 102 can include a hitch 106. In various instances, the trailer 104 can be physically connected, attached, affixed, or otherwise coupled to a rear of the vehicle 102 via the hitch 106. In various cases, the hitch 106 can be any suitable type of mechanical coupling mechanism. As a non-limiting example, the hitch 106 can be any suitable type of receiver ball hitch that is mounted to a frame or unibody of the vehicle 102. As another non-limiting example, the hitch 106 can be any suitable type of pintle hook-and-loop hitch that is mounted to the frame or unibody of the vehicle 102. As yet another non-limiting example, the hitch 106 can be any suitable type of gooseneck ball hitch that is mounted within a bed of the vehicle 102. As still another non-limiting example, the hitch 106 can be any suitable type of fifth-wheel plate hitch that is mounted within the bed of the vehicle 102. As even another non-limiting example, the hitch 106 can be any suitable type of light-duty hitch that is mounted to a bumper of the vehicle 102.

In various cases, the vehicle 102 can have side-view mirrors 108. In various aspects, the side-view mirrors 108 can protrude laterally outward from the vehicle 102, such that one of the side-view mirrors 108 is positioned on a right side of the vehicle 102 while another of the side-view mirrors 108 is positioned on a left side of the vehicle 102. In various instances, the side-view mirrors 108 can be considered as spanning a rearward visual field 110. In other words, the rearward visual field 110 can be considered as demarcating or containing all of the space that lies behind the vehicle 102 and whose reflection can theoretically be depicted within the side-view mirrors 108. Note that there can be a blind-spot 112 within the rearward visual field 110. As shown, the blind-spot 112 can be located immediately or directly behind the trailer 104. In particular, the blind-spot 112 can be formed by two lines-of-sight that extend backward from the side-view mirrors 108, where such two lines-of-sight intersect with each other as closely as possible behind the trailer 104 without intersecting or crossing through or over the trailer 104. In various aspects, a driver of the vehicle 102 can be unable to see the blind-spot 112 in the side-view mirrors 108 (e.g., at least in situations where the trailer 104 is tall enough, or has enough cargo or freight stacked on it, so as to block the driver’s view through a rear window of the vehicle 102), hence the term “blind-spot.” In various instances, a length 114 of the blind-spot 112 can depend upon the length or width of the trailer 104 (e.g., lengthening or widening the trailer 104 can increase the length 114), upon the length or width of the vehicle 102 (e.g., lengthening the vehicle 102 can increase the length 114, whereas widening the vehicle 102 can decrease the length 114), and upon the width of the side-view mirrors 108 (e.g., widening the side-view mirrors 108, such that they stick out farther in a left-right direction, can decrease the length 114). In various cases, if the length 114 is large (e.g., greater than any suitable threshold), the blind-spot 112 can be considered as taking up a larger proportion of the rearward visual field 110, which can mean that less of the rearward visual field 110 is visible to the driver of the vehicle 102. In contrast, if the length 114 is small (e.g., lesser than any suitable threshold), the blind-spot 112 can be considered as taking up a smaller proportion of the rearward visual field 110, which can mean that more of the rearward visual field 110 is visible to the driver of the vehicle 102. Accordingly, when the vehicle 102 tows the trailer 104, it can be desired to ensure that the length 114 is not excessively longer, lest the risk of vehicular collisions be increased.

Note that FIG. 1 depicts an aerial or bird’s-eye view in which non-vertical dimensions of the vehicle 102, of the trailer 104, and of the side-view mirrors 108 create the blind-spot 112. Although not explicitly shown in FIG. 1, it should be understood or otherwise appreciated that, in some cases, the blind-spot 112 can also depend upon vertical dimensions of the vehicle 102 and of the trailer 104. For instance, if the trailer 104 is so tall as to obstruct a rear window of the vehicle 102, then the blind-spot 112 can be as shown in FIG. 1. However, if the trailer 104 is instead so short as to be much lower than the rear window of the vehicle 102, then the blind-spot 112 can be fully or partially visible to the driver through the rear window.

In any case, the vehicle 102 can include a system 116. In other words, the system 116 can be onboard the vehicle 102. Moreover, in various aspects, the trailer 104 can include a transmitter 118, which can exhibit any suitable electronic design or construction. That is, the transmitter 118 can be onboard the trailer 104. In various cases, the system 116 can electronically communicate, in any suitable wired or wireless electronic fashion, with the transmitter 118, so as to help determine whether or not the length 114 is excessively large, as described herein.

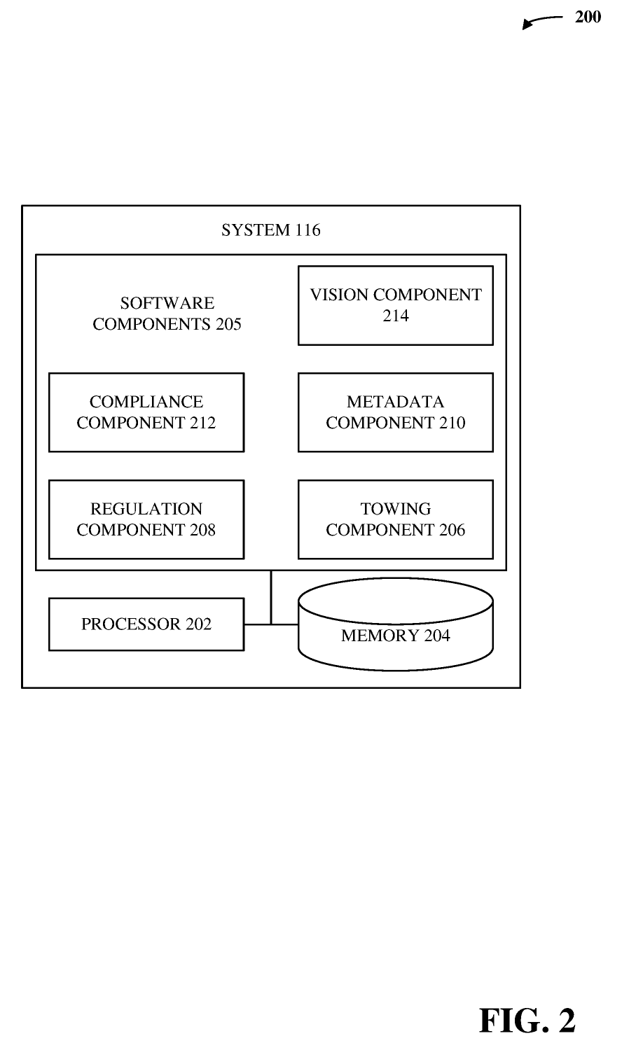

FIG. 2 illustrates an example, non-limiting block diagram 200 of the system 116 that can facilitate towing-triggered visibility compliance indicators in accordance with one or more embodiments described herein.

In various embodiments, the system 116 can include a processor 202 (e.g., computer processing unit, microprocessor) and a non-transitory computer-readable memory 204 that is operably or operatively or communicatively connected or coupled to the processor 202. The non-transitory computer-readable memory 204 can store computer-executable instructions which, upon execution by the processor 202, can cause the processor 202 or other components of the system 116 (e.g., towing component 206, regulation component 208, metadata component 210, compliance component 212, vision component 214) to perform one or more acts. In various embodiments, the non-transitory computer-readable memory 204 can store computer-executable components (e.g., towing component 206, regulation component 208, metadata component 210, compliance component 212, vision component 214), and the processor 202 can execute the computer-executable components.

In various embodiments, the system 116 can include a towing component 206. In various aspects, the towing component 206 can electronically detect whether or not the vehicle 102 is towing the trailer 104.

In various embodiments, the system 116 can include a regulation component 208. In various instances, the regulation component 208 can, in response to the towing component 206 determining that the vehicle 102 is towing the trailer 104, electronically identify a towing visibility regulation that applies to or otherwise governs the vehicle 102.

In various embodiments, the system 116 can include a metadata component 210. In various cases, the metadata component 210 can, in response to the towing component 206 determining that the vehicle 102 is towing the trailer 104, electronically access geometric data regarding the trailer 104 and regarding the vehicle 102.

In various embodiments, the system 116 can include a compliance component 212. In various aspects, the compliance component 212 can electronically determine whether or not the geometric data are in compliance with the towing visibility regulation identified by the regulation component 208.

In various embodiments, the system 116 can include a vision component 214. In various instances, the vision component 214 can, in response to the compliance component 212 determining that the geometric data are in compliance with the towing visibility regulation, electronically verify such compliance by leveraging computer vision.

Note that, in various instances, the towing component 206, the regulation component 208, the metadata component 210, the compliance component 212, and the vision component 214 can collectively be considered as being one or more software components 205 of the system 116. In various aspects, it should be appreciated that the one or more software components 205 are described primarily herein as comprising five components (e.g., the towing component 206, the regulation component 208, the metadata component 210, the compliance component 212, and the vision component 214) for ease of explanation and illustration. However, the one or more software components 205 are not limited to being implemented as exactly such five components in every embodiment. Indeed, in some embodiments, the functionalities described herein of such five components can be combined in any suitable fashions, so as to be implemented in or by fewer than five components (e.g., in some cases, a single component can perform all of the functionalities that are described herein with respect to the towing component 206, the regulation component 208, the metadata component 210, the compliance component 212, and the vision component 214). In other embodiments, the functionalities described herein of such five components can instead be distributed, separated, split, or fragmented in any suitable fashions, so as to be implemented in or by more than five components (e.g., two or more components can facilitate the functionalities that are performable by the towing component 206; two or more components can facilitate the functionalities that are performable by the regulation component 208; two or more components can facilitate the functionalities that are performable by the metadata component 210; two or more components can facilitate the functionalities that are performable by the compliance component 212; two or more components can facilitate the functionalities that are performable by the vision component 214).

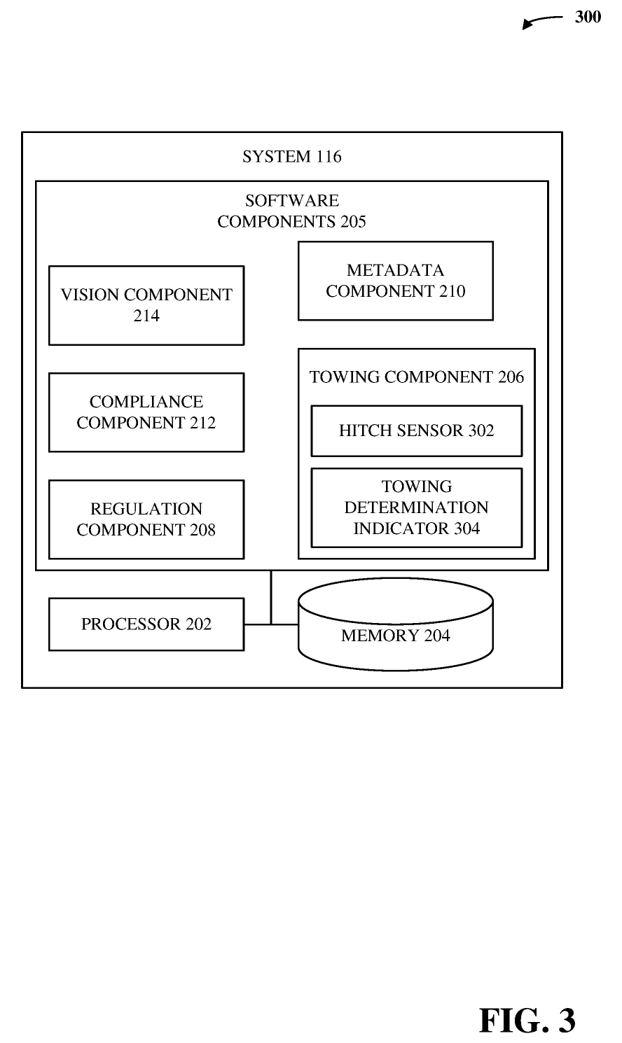

FIG. 3 illustrates an example, non-limiting block diagram 300 showing the system 116 including a hitch sensor and a towing determination indicator that can facilitate towing-triggered visibility compliance indicators in accordance with one or more embodiments described herein. In particular, the towing component 206 can electronically leverage a hitch sensor 302 so as to generate a towing determination indicator 304.

In various embodiments, the hitch sensor 302 can be any suitable electrical, mechanical, or electromechanical sensor that can monitor the hitch 106 of the vehicle 102, so as to detect when or whether the vehicle 102 is towing the trailer 104. In other words, the hitch sensor 302 can continually or continuously provide some sort of time-dependent readout signal, where one possible value or magnitude of that time-dependent readout signal can be indicative of the trailer 104 being physically coupled to the hitch 106, and where some other possible value or magnitude of that time-dependent readout signal can instead be indicative of the trailer 104 not being physically coupled to the hitch 106.

As a non-limiting example, the hitch sensor 302 can be any suitable type of pressure transducer. In such case, the hitch sensor 302 can be considered as measuring or quantifying an amount of force, weight, or pressure that presses downward upon the hitch 106 at each current or present moment or instant in time. For any given moment or instant in time during which the measured amount of force, weight, or pressure pressing downward on the hitch 106 is below any suitable threshold value, the towing component 206 can conclude that the trailer 104 is not physically coupled to the hitch 106 at that given moment or instant in time (e.g., if the trailer 104 were physically coupled to the hitch 106, its tongue weight would be expected to be pressing downward on the hitch 106). On the other hand, for any given moment or instant in time during which the measured amount of force, weight, or pressure pressing downward on the hitch 106 is above any suitable threshold value, the towing component 206 can conclude that the trailer 104 is physically coupled to the hitch 106 at that given moment or instant in time.

As another non-limiting example, the hitch sensor 302 can be any suitable type of strain gauge or potentiometer. In such case, the hitch sensor 302 can be considered as measuring or quantifying an amount of downward displacement or deflection experienced by the hitch 106 at each current or present moment or instant in time. For any given moment or instant in time during which the measured amount of downward displacement or deflection of the hitch 106 is below any suitable threshold value, the towing component 206 can conclude that the trailer 104 is not physically coupled to the hitch 106 at that given moment or instant in time (e.g., if the trailer 104 were physically coupled to the hitch 106, its tongue weight would be expected to displace or deflect the hitch 106 some non-zero distance downward). On the other hand, for any given moment or instant in time during which the measured amount of downward displacement or deflection of the hitch 106 is above any suitable threshold value, the towing component 206 can conclude that the trailer 104 is physically coupled to the hitch 106 at that given moment or instant in time.

As even another non-limiting example, the hitch sensor 302 can be any suitable type of continuity detector. In such case, the hitch sensor 302 can include two electrodes that are positioned on the hitch 106 but that are electrically insulated or isolated from each other, and the hitch sensor 302 can detect the presence or absence of electrical continuity between those two electrodes at each current or present moment or instant in time. For any given moment or instant in time during which there is no electrical continuity between the two electrodes (e.g., during which there is an open circuit between the two electrodes), the towing component 206 can conclude that the trailer 104 is not physically coupled to the hitch 106 at that given moment or instant in time (e.g., if the trailer 104 were physically coupled to the hitch 106, the trailer 104 would be expected to complete the circuit and thereby establish electrical continuity between the two electrodes). On the other hand, for any given moment or instant in time during which there is electrical continuity between the two electrodes (e.g., during which there is a closed circuit between the two electrodes), the towing component 206 can conclude that the trailer 104 is physically coupled to the hitch 106 at that given moment or instant in time.

As still another non-limiting example, the hitch sensor 302 can be any suitable type of photoresistor. In such case, the hitch sensor 302 can be considered as measuring or quantifying an amount of light that is incident or shining upon the hitch 106 at each current or present moment or instant in time. For any given moment or instant in time during which the measured amount of light incident or shining upon the hitch 106 is above any suitable threshold value, the towing component 206 can conclude that the trailer 104 is not physically coupled to the hitch 106 at that given moment or instant in time (e.g., if the trailer 104 were physically coupled to the hitch 106, it would be expected to physically cover the hitch 106 and thereby prevent light from shining on the photoresistor). On the other hand, for any given moment or instant in time during which the measured amount of light incident or shining upon the hitch 106 is below any suitable threshold value, the towing component 206 can conclude that the trailer 104 is physically coupled to the hitch 106 at that given moment or instant in time.

No matter the design or construction of the hitch sensor 302, the towing component 206 can leverage the hitch sensor 302 so as to determine, at regular or periodic moments in time, whether or not the trailer 104 is physically coupled to the hitch 106, and thereby whether or not the vehicle 102 is currently or presently towing the trailer 104. Whatever electronic data that indicates or represents such determination can be referred to as the towing determination indicator 304. In other words, the towing determination indicator 304 can be one or more scalars, one or more vectors, one or more matrices, one or more tensors, one or more character strings, or any suitable combination thereof which the towing component 206 generates based on the readout signal of the hitch sensor 302 and which specifies, indicates, conveys, or otherwise represents whether or not the vehicle 102 is currently or presently towing the trailer 104.

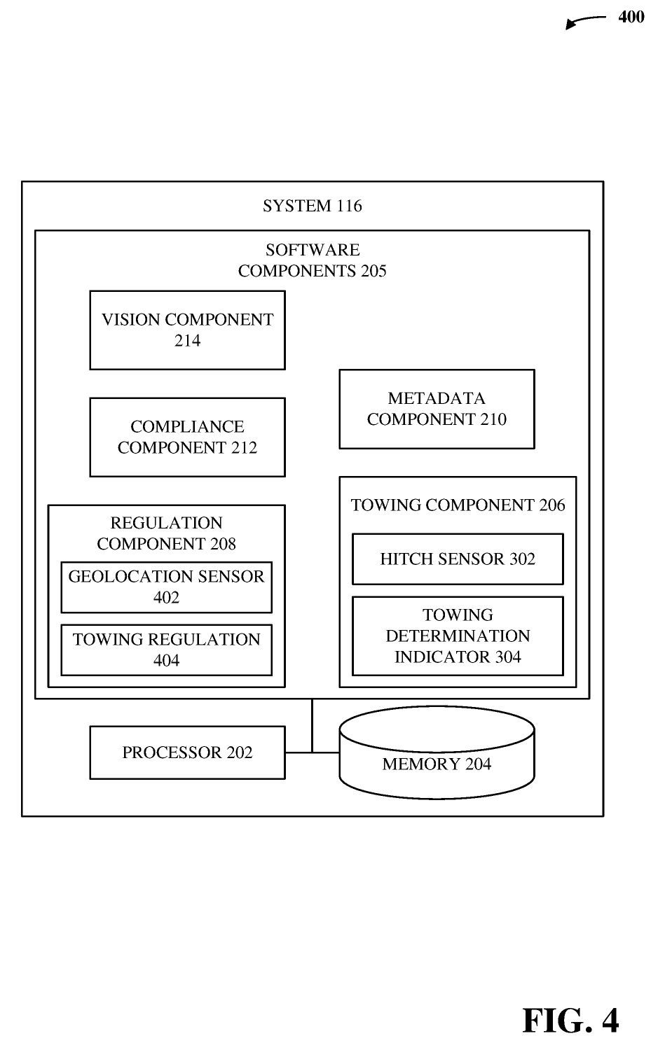

FIG. 4 illustrates an example, non-limiting block diagram 400 of the system 116 including a global positioning sensor and a towing regulation that can facilitates towing-triggered visibility compliance indicators in accordance with one or more embodiments described herein. In particular, the regulation component 208 can, in response to the towing determination indicator 304 indicating that the vehicle 102 is currently or presently towing the trailer 104, electronically leverage a geolocation sensor 402 so as to identify a towing regulation 404.

In various embodiments, the geolocation sensor 402 can be any suitable electronic sensor that can monitor the geolocation of the vehicle 102. In other words, the geolocation sensor 402 can continually or continuously provide some sort of time-dependent readout signal, where the specific value or magnitude of that time-dependent readout signal can be indicative of where on the planet the vehicle 102 is currently or presently located. As a non-limiting example, the geolocation sensor 402 can be a global positioning system (GPS) sensor that triangulates where in the world the vehicle 102 is located based on measured distances between the vehicle 102 and orbiting satellites. As another non-limiting example, the geolocation sensor 402 can be a Wi-Fi positioning system (WPS) sensor that estimates where in the world the vehicle 102 is located based on a known location of whatever Wi-Fi network the vehicle 102 is electronically accessing. As yet another non-limiting example, the geolocation sensor 402 can be a cellular positioning system sensor that triangulates where in the world the vehicle 102 is located based on pinging cell towers that are closest or nearest to the vehicle 102. As still another non-limiting example, the geolocation sensor 402 can be a Bluetooth positioning system sensor that estimates where in the world the vehicle 102 is located based on a known location of whatever Bluetooth beacon is closest or nearest to the vehicle 102. In any case, the geolocation sensor 402 can measure or determine the geolocation of the vehicle 102 at any given moment or instant in time. It should be understood or otherwise appreciated that the geolocation sensor 402 can measure geolocation according to any suitable level of specificity or granularity. As a non-limiting example, the geolocation sensor 402 can measure geolocation in terms of: latitude; longitude; elevation; continent; country; state or province; city; street; or address.

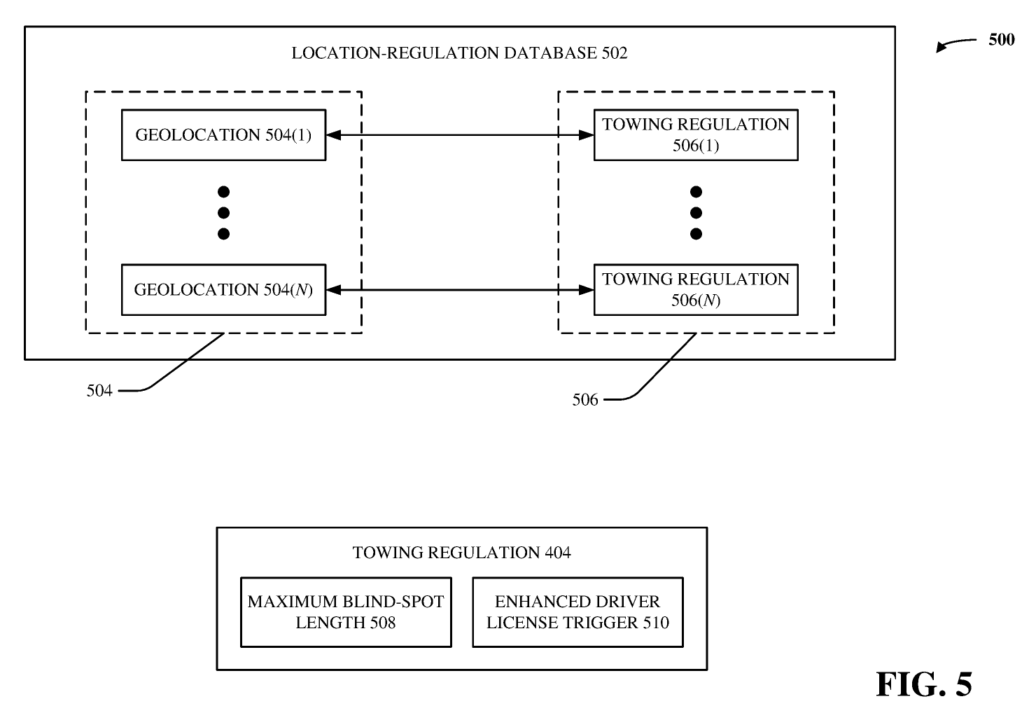

No matter the design or construction of the geolocation sensor 402, the regulation component 208 can leverage the geolocation sensor 402 to identify the towing regulation 404. Non-limiting aspects are described with respect to FIG. 5.

FIG. 5 illustrates an example, non-limiting block diagram 500 of a location-regulation database 502 and the towing regulation 404 in accordance with one or more embodiments described herein.

In various embodiments, the regulation component 208 can electronically access the location-regulation database 502. In various aspects, the location-regulation database 502 can be considered as a mapping between geolocations and towing regulations. More specifically, the location-regulation database 502 can include a plurality of geolocations 504 and a plurality of towing regulations 506. In various instances, the plurality of geolocations 504 can include n distinct or different geolocations for any suitable positive integer n: a geolocation 504(1) to a geolocation 504(n). In various cases, the plurality of towing regulations 506 can respectively correspond (e.g., in one-to-one fashion) with the plurality of geolocations 504. Thus, since the plurality of geolocations 504 can include n geolocations, the plurality of towing regulations 506 can include n regulations: a towing regulation 506(1) to a towing regulation 506(n). In various aspects, each of the plurality of towing regulations 506 can be a respective law that governs vehicular towing in a respective one of the plurality of geolocations 504. As a non-limiting example, the towing regulation 506(1) can be whatever law that governs vehicular towing in the geolocation 504(1). As another non-limiting example, the towing regulation 506(n) can be whatever law that governs vehicular towing in the geolocation 504(n). Note that, although no two of the plurality of geolocations 504 can be identical to each other, any two or more of the plurality of towing regulations 506 can be identical to each other (e.g., some geolocations can have the same towing laws as each other).

In response to the towing determination indicator 304 indicating that the vehicle 102 is currently or presently towing the trailer 104, the regulation component 208 can search through the location-regulation database 502 for whichever one of the plurality of towing regulations 506 corresponds to a current or present geolocation of the vehicle 102 as indicated by the geolocation sensor 402. That is, whatever geolocation is currently or presented readout by the geolocation sensor 402 can be considered as the current or present geolocation of the vehicle 102, that current or present geolocation can be specified somewhere within the plurality of geolocations 504, and thus that current or present geolocation can correspond to one of the plurality of towing regulations 506. Whichever one of the plurality of towing regulations 506 corresponds to the current or present geolocation of the vehicle 102 can be referred to as the towing regulation 404. Thus, the towing regulation 404 can be considered as legally governing, restricting, or otherwise limiting vehicular towing in the physical geographic area in which the vehicle 102 is currently or presently located.

In some instances, the towing regulation 404 can specify a maximum blind-spot length 508. In various cases, the maximum blind-spot length 508 can be a scalar whose value represents an upper bound for the length 114 of the blind-spot 112. In other words, whatever geographic region in which the vehicle 102 is currently or presently located can prohibit vehicular towing that involves a blind-spot whose length is greater than the maximum blind-spot length 508. In other words, whatever geographic region in which the vehicle 102 is currently or presently located can permit vehicular towing only when such towing involves a blind-spot whose length is less than or equal to the maximum blind-spot length 508. In various aspects, the maximum blind-spot length 508 can thus be considered as defining, delineating, or demarcating a minimum permissible amount of rearward visibility that must be had when towing within the current or present geolocation of the vehicle 102. Because of this, the towing regulation 404 can be alternatively referred to as a towing visibility regulation. Note that the towing regulation 404 can be considered as more stringent as the maximum blind-spot length 508 decreases (e.g., as less of the rearward visual field 110 is permitted to be taken up by the blind-spot 112). Conversely, note that the towing regulation 404 can instead be considered as more lenient as the maximum blind-spot length 508 increases (e.g., as more of the rearward visual field 110 is permitted to be taken up by the blind-spot 112).

In some instances, the towing regulation 404 can further specify an enhanced driver license trigger 510. In various cases, the enhanced driver license trigger 510 can be a scalar indicating a maximum amount of combined or total weight rating that is permitted to be driven or towed in the current or present geolocation of the vehicle 102 without an enhanced or higher-order driver license (e.g., without a commercial driver license (CDL)).

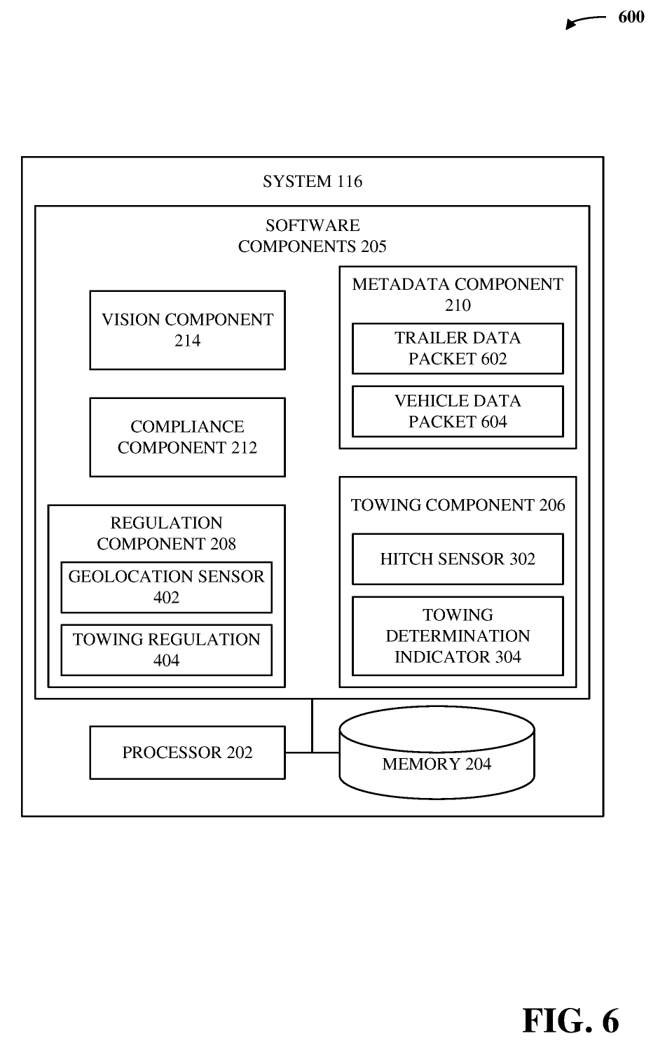

FIG. 6 illustrates an example, non-limiting block diagram 600 of the system 116 including a trailer data packet and a vehicle data packet that can facilitate towing-triggered visibility compliance indicators in accordance with one or more embodiments described herein. In particular, the metadata component 210 can, in response to the towing determination indicator 304 indicating that the vehicle 102 is currently or presently towing the trailer 104, electronically access a trailer data packet 602 and a vehicle data packet 604.

In various embodiments, the trailer data packet 602 can be electronically stored within any suitable computer memory that is onboard the trailer 104, and the transmitter 118 can electronically broadcast the trailer data packet 602 or otherwise make the trailer data packet 602 wirelessly available or discoverable. In response to the towing determination indicator 304 indicating that the vehicle 102 is currently or presently towing the trailer 104, the metadata component 210 can electronically receive, electronically retrieve, electronically discover, or otherwise electronically obtain the trailer data packet 602 from the transmitter 118.

In various aspects, the vehicle data packet 604 can be electronically stored within the memory 204 that is onboard the vehicle 102. So, in response to the towing determination indicator 304 indicating that the vehicle 102 is currently or presently towing the trailer 104, the metadata component 210 can electronically receive, electronically retrieve, electronically discover, or otherwise electronically obtain the vehicle data packet 604 from the memory 204.

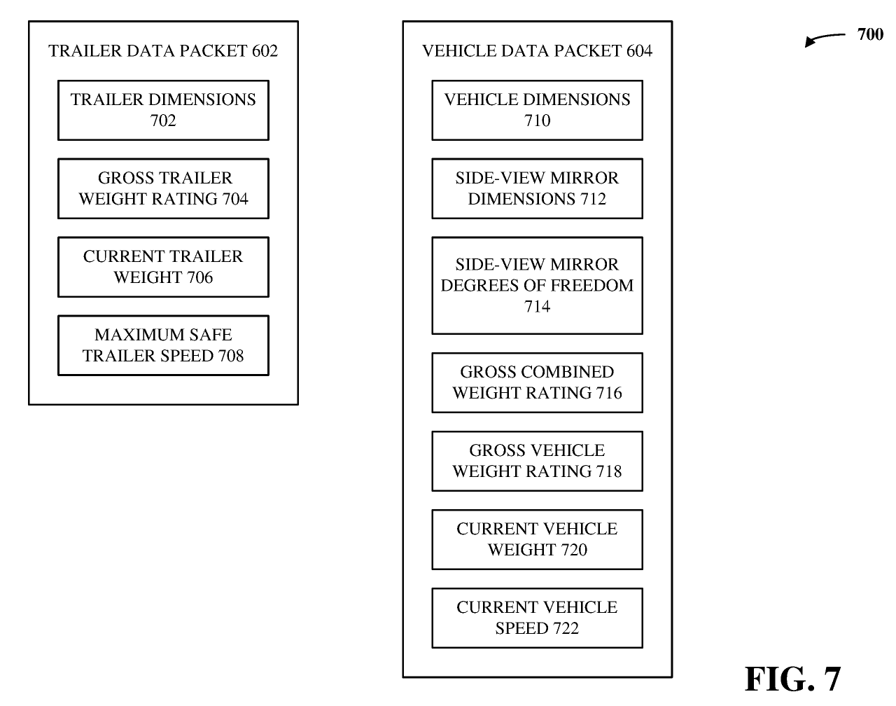

In any case, the trailer data packet 602 and the vehicle data packet 604 can respectively specify any suitable metadata or attributes pertaining to the trailer 104 and the vehicle 102. Non-limiting aspects are described with respect to FIG. 7.

FIG. 7 illustrates an example, non-limiting block diagram 700 showing the trailer data packet 602 and the vehicle data packet 604 in accordance with one or more embodiments described herein.

In various embodiments, the trailer data packet 602 can specify, indicate, convey, or otherwise include one or more trailer dimensions 702. In various aspects, the one or more trailer dimensions 702 can be one or more scalars, each representing a respective geometric dimension or linear geometric size of the trailer 104. As a non-limiting example, a first scalar of the one or more trailer dimensions 702 can be or represent a front-to-back length of the trailer 104 as measured in any suitable units (e.g., meters, feet). As another non-limiting example, a second scalar of the one or more trailer dimensions 702 can be or represent a right-to-left width of the trailer 104 as measured in any suitable units. As yet another non-limiting example, a third scalar of the one or more trailer dimensions 702 can be or represent a top-to-bottom height of the trailer 104 as measured in any suitable units. In various instances, the one or more trailer dimensions 702 can be considered as fixed, immutable, or from-the-factory attributes of the trailer 104 that can be stored permanently in whatever computer memory is onboard the trailer 104.

In various cases, the trailer data packet 602 can specify, indicate, convey, or otherwise include a gross trailer weight rating 704. In various aspects, the gross trailer weight rating 704 can be a scalar that represents a maximum amount of weight that the trailer 104 is designed to safely carry or haul. In various instances, the gross trailer weight rating 704 can be inclusive of an empty or dry curb weight of the trailer 104. In other words, the gross trailer weight rating 704 can be an upper bound on a sum between: the empty or dry curb weight of the trailer 104; and the total amount of cargo or freight that is loaded onto the trailer 104 at any given time. Just as above, the gross trailer weight rating 704 can be considered as a fixed, immutable, or from-the-factory attribute of the trailer 104 that can be stored permanently in whatever computer memory is onboard the trailer 104.

In various aspects, the trailer data packet 602 can specify, indicate, convey, or otherwise include a current trailer weight 706. In various aspects, the current trailer weight 706 can be a scalar that represents how much the trailer 104 weighs at a current or present moment in time (e.g., at the moment or instant that the metadata component 210 obtains or retrieves the trailer data packet 602). Indeed, the trailer 104 can, in various instances, be outfitted or equipped with any suitable onboard weight sensor which can measure or record an instantaneous amount of weight that is supported by the axles of the trailer 104. Whatever readout signal is indicated by that onboard weight sensor at the time at which the metadata component 210 receives or retrieves the trailer data packet 602 can be referred to as the current trailer weight 706. Note that the current trailer weight 706 can be not fixed or not immutable. Instead, the current trailer weight 706 can vary or fluctuate over time (e.g., as more or less cargo or freight is added to or removed from the trailer 104).

In various cases, the trailer data packet 602 can specify, indicate, convey, or otherwise include a maximum safe trailer speed 708. In various aspects, the maximum safe trailer speed 708 can be a scalar that represents a maximum roadway speed or roadway velocity that the trailer 104 is designed to safely travel. In various instances, the maximum safe trailer speed 708 can be expressed in any suitable units (e.g., miles per hour; kilometers per hour; meters per second). Just as above, the maximum safe trailer speed 708 can be considered as a fixed, immutable, or from-the-factory attribute of the trailer 104 that can be stored permanently in whatever computer memory is onboard the trailer 104.

In various embodiments, the vehicle data packet 604 can specify, indicate, convey, or otherwise include one or more vehicle dimensions 710. In various aspects, the one or more vehicle dimensions 710 can be one or more scalars, each representing a respective geometric dimension or linear geometric size of the vehicle 102. As a non-limiting example, a first scalar of the one or more vehicle dimensions 710 can be or represent a front-to-back length of the vehicle 102 as measured in any suitable units (e.g., meters, feet). As another non-limiting example, a second scalar of the one or more vehicle dimensions 710 can be or represent a right-to-left width of the vehicle 102 as measured in any suitable units. As yet another non-limiting example, a third scalar of the one or more vehicle dimensions 710 can be or represent a top-to-bottom height of the vehicle 102 as measured in any suitable units. As still another non-limiting example, a fourth scalar of the one or more vehicle dimensions 710 can be or represent how much of the front-to-back length of the vehicle 102 is located forward of the side-view mirrors 108 or rearward of the side-view mirrors 108. In various instances, the one or more vehicle dimensions 710 can be considered as fixed, immutable, or from-the-factory attributes of the vehicle 102 that can be stored permanently in the memory 204.

In various cases, the vehicle data packet 604 can specify, indicate, convey, or otherwise include one or more side-view mirror dimensions 712. In various aspects, the one or more side-view mirror dimensions 712 can be one or more scalars, each representing a respective geometric dimension or linear geometric size of the side-view mirrors 108. As a non-limiting example, a first scalar of the one or more side-view mirror dimensions 712 can be or represent a front-to-back length of each of the side-view mirrors 108 as measured in any suitable units (e.g., meters, feet). As another non-limiting example, a second scalar of the one or more side-view mirror dimensions 712 can be or represent a right-to-left width of each of the side-view mirrors 108 as measured in any suitable units. As yet another non-limiting example, a third scalar of the one or more side-view mirror dimensions 712 can be or represent a top-to-bottom height of each of the side-view mirrors 108 as measured in any suitable units. As still another non-limiting example, a fourth scalar of the one or more side-view mirror dimensions 712 can be or represent a horizontal angular tilt of each of the side-view mirrors 108 as measured in any suitable units (e.g., degrees, radians). As even another non-limiting example, a fifth scalar of the one or more side-view mirror dimensions 712 can be or represent a vertical angular tilt of each of the side-view mirrors 108 as measured in any suitable units. In some cases, as above, the one or more side-view mirror dimensions 712 can be considered as fixed, immutable, or from-the-factory attributes of the vehicle 102 that can be stored permanently in the memory 204. Indeed, this can occur in situations where the side-view mirrors 108 are non-extendible, non-telescoping, or otherwise of fixed-width from the factory. However, in other cases, it can be possible that the side-view mirrors 108 are extendible, telescoping, or otherwise of variable-width, either from the factory or due to after-market upgrades. In such situations, the one or more side-view mirror dimensions 712 can specify the lengths, widths, or heights that the side-view mirrors 108 have at the current or present time (e.g., as the moment or instant when the metadata component 210 receives or retrieves the vehicle data packet 604 from the memory 204).

In various aspects, the vehicle data packet 604 can specify, indicate, convey, or otherwise include one or more side-view mirror degrees of freedom 714. In various instances, the one or more side-view mirror degrees of freedom 714 can be one or more real-valued intervals, each representing a respective physical degree of freedom of each of the side-view mirrors 108. As a non-limiting example, a first real-valued interval of the one or more side-view mirror degrees of freedom 714 can be or represent a range of extendible width positions (e.g., ranging from a minimum or fully-retracted width position to a maximum or fully-extended width position) that the side-view mirrors 108 can be selectively or controllably forced to occupy (e.g., via any suitable buttons or joysticks of the vehicle 102). Note that the one or more side-view mirror dimensions 712 can specify where in that range of extendible width positions the side-view mirrors 108 are currently or presently positioned. As another non-limiting example, a second real-valued interval of the one or more side-view mirror degrees of freedom 714 can be or represent a range of horizontal angular tilts (e.g., ranging from a maximally-rightward tilt to a maximally-leftward tilt) that the side-view mirrors 108 can be selectively or controllably forced to occupy. Note that the one or more side-view mirror dimensions 712 can specify where in that range of horizontal angular tilts the side-view mirrors 108 are currently or presently positioned. As yet another non-limiting example, a third real-valued interval of the one or more side-view mirror degrees of freedom 714 can be or represent a range of vertical angular tilts (e.g., ranging from a maximally-upward tilt to a maximally-downward tilt) that the side-view mirrors 108 can be selectively or controllably forced to occupy. Note that the one or more side-view mirror dimensions 712 can specify where in that range of vertical angular tilts the side-view mirrors 108 are currently or presently positioned.

In various aspects, the vehicle data packet 604 can specify, indicate, convey, or otherwise include a gross combined weight rating 716. In various instances, the gross combined weight rating 716 can be a scalar that represents a maximum amount of weight that the vehicle 102 is designed to safely carry, haul, and tow at any given time. In various cases, the gross combined weight rating 716 can be inclusive of an empty or dry curb weight of the vehicle 102. In other words, the gross combined weight rating 716 can be an upper bound on a sum between: the empty or dry curb weight of the vehicle 102; the empty or dry curb weight of the trailer 104; and the total amount of cargo or freight that is loaded onto the trailer 104 or onto the vehicle 102 at any given time. In various cases, the gross combined weight rating 716 can be considered as a fixed, immutable, or from-the-factory attribute of the vehicle 102 that can be stored permanently in the memory 204.

In various aspects, the vehicle data packet 604 can specify, indicate, convey, or otherwise include a gross vehicle weight rating 718. In various instances, the gross vehicle weight rating 718 can be a scalar that represents a maximum amount of weight of cargo or freight that the vehicle 102 is designed to safely carry or haul on its frame. In various cases, the gross vehicle weight rating 718 can be inclusive of empty or dry curb weight of the vehicle 102 and of tongue weight from the trailer 104. In other words, the gross vehicle weight rating 718 can be an upper bound on a sum between: the empty or dry curb weight of the vehicle 102; the total amount of cargo or freight that is loaded onto the vehicle 102 at any given time; and the tongue weight exerted by the trailer 104 onto the vehicle 102 at any given time. As above, the gross vehicle weight rating 718 can be considered as a fixed, immutable, or from-the-factory attribute of the vehicle 102 that can be stored permanently in the memory 204.

In various cases, the vehicle data packet 604 can specify, indicate, convey, or otherwise include a current vehicle weight 720. In various aspects, the current vehicle weight 720 can be a scalar that represents how much the vehicle 102 weighs at a current or present moment in time (e.g., at the moment or instant that the metadata component 210 obtains or retrieves the vehicle data packet 604). Indeed, the vehicle 102 can, in various instances, be outfitted or equipped with any suitable onboard weight sensor which can measure or record an instantaneous amount of weight that is supported by the axles of the vehicle 102. Whatever readout signal is indicated by that onboard weight sensor at the time at which the metadata component 210 receives or retrieves the vehicle data packet 604 can be referred to as the current vehicle weight 720. Note that the current vehicle weight 720 can be not fixed or not immutable. Instead, the current vehicle weight 720 can vary or fluctuate over time (e.g., as more or less cargo, freight, or tongue weight is added to or removed from the vehicle 102).

In various aspects, the vehicle data packet 604 can specify, indicate, convey, or otherwise include a current vehicle speed 722. In various aspects, the current vehicle speed 722 can be a scalar that represents how quickly the vehicle 102 is traveling at the current or present moment in time. Indeed, the vehicle 102 can, in various instances, be outfitted or equipped with any suitable speedometer or speed sensor which can measure or record an instantaneous roadway speed or roadway velocity of the vehicle 102. Whatever readout signal is indicated by that onboard speedometer or speed sensor at the time at which the metadata component 210 receives or retrieves the vehicle data packet 604 can be referred to as the current vehicle speed 722. Note that the current vehicle speed 722 can be not fixed or not immutable. Instead, the current vehicle speed 722 can vary or fluctuate over time (e.g., as the vehicle 102 slows down or speeds up during travel).

It should be understood or otherwise appreciated that FIG. 7 is a mere non-limiting example of the contents of the trailer data packet 602 and of the vehicle data packet 604.

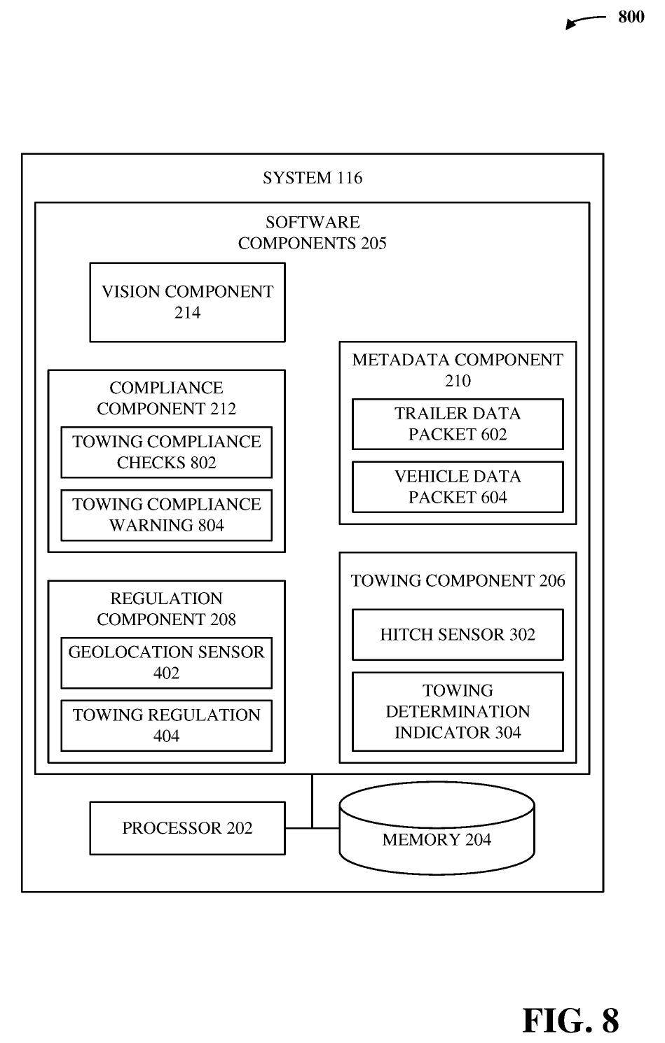

FIG. 8 illustrates an example, non-limiting block diagram 800 of the system 116 including a set of towing compliance checks and a towing compliance warning that can facilitate towing-triggered visibility compliance indicators in accordance with one or more embodiments described herein. In particular, the compliance component 212 can, in response to the towing determination indicator 304 indicating that the vehicle 102 is currently or presenting towing the trailer 104, generate a towing compliance warning 804 based on performing one or more towing compliance checks 802.

In various embodiments, the one or more towing compliance checks 802 can involve comparing the trailer data packet 602 and the vehicle data packet 604 to the towing regulation 404, so as to determine whether or not the vehicle 102 is capable of towing the trailer 104 with sufficient rearward visibility. In some cases, the one or more towing compliance checks 802 can further include comparing the vehicle data packet 604 and the trailer data packet 602 to each other or to themselves, so as to determine whether there are any non-visibility safety concerns with the vehicle 102 towing the trailer 104.

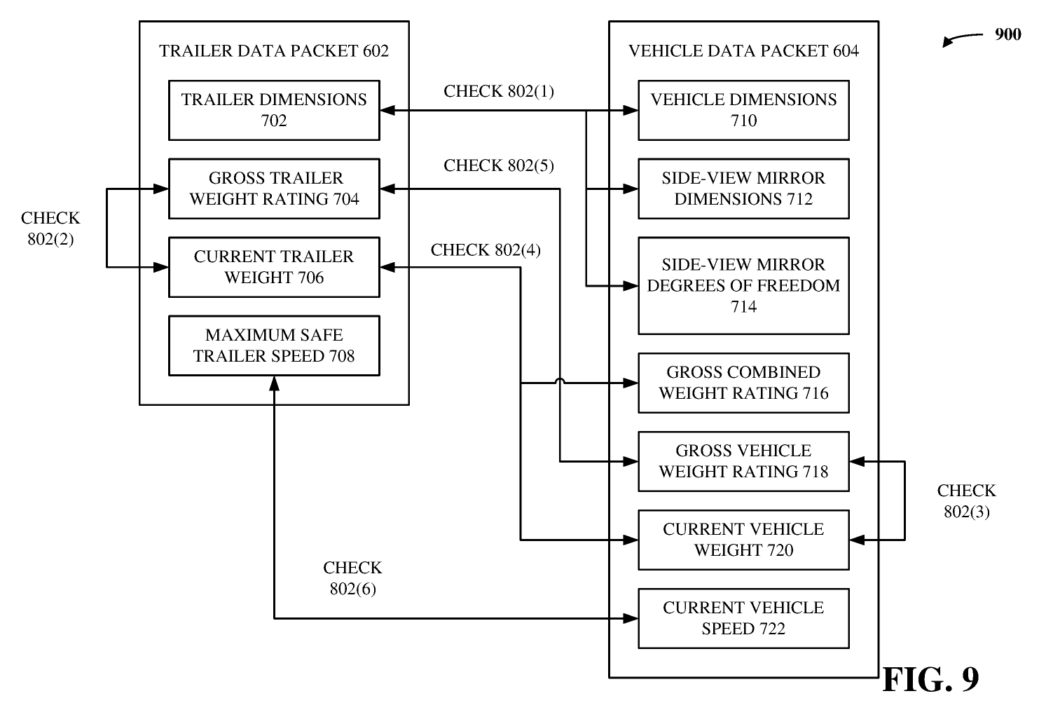

In various aspects, the towing compliance warning 804 can be any suitable electronic message or notification which the compliance component 212 can render on any suitable computer screen or electronic display of the vehicle 102 (e.g., on a center console touchscreen of the vehicle 102; on a heads-up holographic dashboard display of the vehicle 102). In various instances, the towing compliance warning 804 can indicate, relay, or otherwise convey to the driver of the vehicle 102 what, if any, safety issues there might be with respect to the vehicle 102 towing the trailer 104. Various non-limiting aspects are described with respect to FIG. 9.

FIG. 9 illustrates an example, non-limiting block diagram 900 of the one or more towing compliance checks 802 in accordance with one or more embodiments described herein.

In various embodiments, the one or more towing compliance checks 802 can include a check 802(1). In various aspects, the compliance component 212 can perform the check 802(1) by analyzing the one or more trailer dimensions 702, the one or more vehicle dimensions 710, the one or more side-view mirror dimensions 712, or the one or more side-view mirror degrees of freedom 714, in light of the maximum blind-spot length 508. In other words, the check 802(1) can be considered as determining whether or not the physical sizes of the vehicle 102, the trailer 104, and the side-view mirrors 108 are violative of the towing regulation 404.

In various cases, the check 802(1) can involve the compliance component 212 identifying: a height of the trailer 104 (e.g., a distance from the ground to a top of the trailer 104) within the one or more trailer dimensions 702; a length of the trailer 104 (e.g., a distance from a front-most point of the trailer 104 to a rear-most point of the trailer 104) within the one or more trailer dimensions 702; and a height of a rear window of the vehicle 102 (e.g., a distance from the ground to the rear window) within the one or more vehicle dimensions 710. In various aspects, the compliance component 212 can compute a first estimate of the length 114 of the blind-spot 112, based on the height of the trailer 104, the height of the rear window of the vehicle 102, and the length of the trailer 104. More specifically, a line-of-sight can be considered as extending from the rear window of the vehicle 102 toward a rear-most point of the trailer 104. The amount of distance which that rear-most point is located above the ground or roadway can be considered as being equal to the height of the trailer 104. Additionally, the amount of distance which that rear-most point is located behind the vehicle 102 can be equal to the length of the trailer 104. Thus, the slope of that line-of-sight can be known (e.g., can be equal to a quotient obtained by dividing: a difference between the height of the rear window and the height of the trailer 104; by the length of the trailer 104). In various instances, that line-of-sight can be linearly extended or extrapolated with constant slope in a rearward direction until it intersects with the ground or roadway (e.g., until that line-of-sight has fallen a vertical distance equal to the height of the trailer 104). Whatever horizontal distance past the rear-most point of the trailer 104 that such line-of-sight traverses to get to that point of intersection can be considered as being the first estimate of the length 114.

In response to that first estimate of the length 114 being less than the maximum blind-spot length 508, the compliance component 212 can conclude that the vehicle 102 and the trailer 104 are sized such that the blind-spot 112 (e.g., when viewed by the driver through the rear window of the vehicle 102) is small enough to comply with the towing regulation 404. However, in response to that first estimate of the length 114 being greater than the maximum blind-spot length 508, the compliance component 212 can compute a second estimate of the length 114.

Specifically, in response to that first estimate of the length 114 being greater than the maximum blind-spot length 508, the compliance component 212 can identify: the length of the trailer 104 within the one or more trailer dimensions 702; a mirror-truncated length of the vehicle 102 (e.g., a distance from a rear-most point of the vehicle 102 to the location of the side-view mirrors 108) within the one or more vehicle dimensions 710; a width of the trailer 104 (e.g., a distance from a right-most point of the trailer 104 to a left-most point of the trailer 104) within the one or more trailer dimensions 702; a width of the vehicle 102 (e.g. a distance from a right-most point of the vehicle 102 to a left-most point of the vehicle 102) within the one or more vehicle dimensions 710; and a current or present-time width of each of the side-view mirrors 108 (e.g., a current or present-time distance from a right-most or left-most base of one the side-view mirrors 108 to a left-most or right-most tip of that one of the side-view mirrors 108) within the one or more side-view mirror dimensions 712. In various aspects, the compliance component 212 can compute the second estimate of the length 114 of the blind-spot 112, based on the length of the trailer 104, the mirror-truncated length of the vehicle 102, the width of the trailer 104, the width of the vehicle 102, and the current or present-time width of each of the side-view mirrors 108. More specifically, a left line-of-sight can be considered as extending rearward from a left one of the side-view mirrors 108 and can pass through a left-most point of a rear-most cross-section of the trailer 104. The amount of distance which that left-most point of the rear-most cross-section is located behind the left one of the side-view mirrors 108 can be equal to a sum of the length of the trailer 104 and the mirror-truncated length of the vehicle 102. Additionally, the amount of left-to-right horizontal displacement between the left one of the side-view mirrors 108 and the left-most point of the rear-most cross-section of the trailer 104 can be equal to a difference between: half the width of the trailer 104; and a sum of half the width of the vehicle 102 and the current or present-time width of one of the side-view mirrors 108. Thus, the slope of that left line-of-sight can be known (e.g., can be equal to a quotient obtained by dividing: the amount of left-to-right horizontal displacement between the left one of the side-view mirrors 108 and the left-most point of the rear-most cross-section of the trailer 104; by the amount of distance which that left-most point of the rear-most cross-section is located behind the left one of the side-view mirrors 108). Analogously, a right line-of-sight can be considered as extending rearward from a right one of the side-view mirrors 108 and can pass through a right-most point of the rear-most cross-section of the trailer 104 with known slope. Note that the slope of the right line-of-sight can be equal in magnitude but of opposite sign as the slope of the left line-of-sight. In any case, the left and right lines-of-sight can be linearly extended or extrapolated with constant respective slopes in a rearward direction until they intersect with each other. Whatever horizontal distance past the rear-most cross-section of the trailer 104 that the left and right lines-of-sight traverse to get to that point of intersection can be considered as being the second estimate of the length 114.

In response to that second estimate of the length 114 being less than the maximum blind-spot length 508, the compliance component 212 can conclude that the vehicle 102, the side-view mirrors 108, and the trailer 104 are sized such that the blind-spot 112 (e.g., when viewed by the driver through the side-view mirrors 108) is small enough to comply with the towing regulation 404. However, in response to that second estimate of the length 114 being greater than the maximum blind-spot length 508, the compliance component 212 can consult the one or more side-view mirror degrees of freedom 714 and can perform any suitable electronic action based on such consultation.

In particular, if the one or more side-view mirror degrees of freedom 714 indicate or specify that the side-view mirrors 108 are fixed, non-extendible, or non-telescoping, then the compliance component 212 can conclude that the vehicle 102, the side-view mirrors 108, and the trailer 104 are sized in such a way that the blind-spot 112 is too large to comply with the towing regulation 404. In such situation, the compliance component 212 can render the towing compliance warning 804 on any suitable electronic display of the vehicle 102, and the towing compliance warning 804 can indicate, specify, or otherwise convey the fact that the vehicle 102, the side-view mirrors 108, and the trailer 104 are collectively not sized appropriately to comply with the towing regulation 404.

In some of such situations, the towing compliance warning 804 can recommend that an external or extrinsic attachment be equipped onto or over each of the side-view mirrors 108, where such external or extrinsic attachment would cause the blind-spot 112 to become compliant with the towing regulation 404. As a non-limiting example, the external or extrinsic attachment can be an auxiliary mirror that artificially increases the current or present-time width of each of the side-view mirrors 108, where such artificial increase in width is by an amount that is sufficient to cause the second estimate of the length 114 to be less than or equal to the maximum blind-spot length 508. Indeed, the compliance component 212 can calculate a minimum amount of such artificial increase in width by assuming that the left and right lines-of-sight respectively pass through the left-most and right-most points of the rear-most cross-section of the trailer 104 and by assuming that their point of intersection with each other is located behind the trailer 104 at a distance equal to the maximum blind-spot length 508. This can cause the left and right lines-of-sight to be respectively separated from the tips of the side-view mirrors 108 by some amount of displacement, and such amount of displacement can be considered as being equal to the minimum amount of artificial width increase that should be provided by the auxiliary mirror. In situations where the towing compliance warning 804 can possibly indicate multiple different types or models of auxiliary mirrors, the towing compliance warning 804 can exclude any of those multiple different types or models that do not provide at least the minimum amount of artificial width increase. Furthermore, the towing compliance warning 804 can also exclude any of those multiple different types or models that would cause the vehicle 102 to be too wide for a standard or average traffic lane. As another non-limiting example, the external or extrinsic attachment can be an electronic screen (e.g., a screen-in-mirror) that can be affixed to the side-view mirrors 108 and that can render a video feed from by any suitable rear-facing camera that is affixed, mounted, or coupled to the trailer 104. For instance, that electronic screen can be located on the side-view mirrors 108 but can render a video feed captured by a camera that is mounted to a rear bumper of the trailer 104.

Now, suppose that the one or more side-view mirror degrees of freedom 714 instead indicate or specify that the side-view mirrors 108 are non-fixed, extendible, or telescoping (e.g., as opposed to fixed, non-extendible, or non-telescoping). In such cases, the compliance component 212 can determine whether the side-view mirrors 108 are capable of extending or telescoping (e.g., via any suitable motorized actuator that is structurally integrated into the side-view mirrors 108) to a new width that is sufficient to cause the second estimate of the length 114 to be less than or equal to the maximum blind-spot length 508. Specifically, as mentioned above, the compliance component 212 can identify a minimum required width that would cause the side-view mirrors 108 to stick out sideways enough such that the second estimate of the length 114 is less than or equal to the maximum blind-spot length 508, by assuming that the left and right lines-of-sight respectively pass through the left-most and right-most points of the rear-most cross-section of the trailer 104 and by assuming that their point of intersection with each other is located behind the trailer 104 at a distance equal to the maximum blind-spot length 508. The compliance component 212 can then consult the one or more side-view mirror degrees of freedom 714 to determine whether or not that minimum required width is within a width extension range of the side-view mirrors 108. If the minimum required width is within the width extension range of the side-view mirrors 108 (e.g., is reachable by the side-view mirrors 108), the compliance component 212 can electronically activate any suitable motorized actuators of the side-view mirrors 108, so as to cause the side-view mirrors 108 to exhibit or otherwise be positioned at or according to that minimum required width. This can be considered as automatically configuring the side-view mirrors 108 to accommodate the geometric dimensions of the trailer 104. In contrast, if the minimum required width is not within the width extension range of the side-view mirrors 108 (e.g., if the minimum required width is beyond a maximum width that the side-view mirrors 108 can extend to), the compliance component 212 can (similar to as described above) cause the towing compliance warning 804 to: indicate, specify, or otherwise convey the fact that the vehicle 102, the side-view mirrors 108, and the trailer 104 are collectively not sized appropriately to comply with the towing regulation 404; or recommend that an appropriately-sized external or extrinsic side-view mirror attachment be obtained.

In some cases, in response to the second estimate of the length 114 of the blind-spot 112 being greater than the maximum blind-spot length 508, the compliance component 212 can electronically disable the vehicle 102, so as to prevent the vehicle 102 from unsafely towing the trailer 104. Such disabling can be in any suitable electromechanical fashion, such as: automatically shifting a transmission of the vehicle 102 into park; automatically engaging brakes of the vehicle 102; or automatically shutting off an engine or motor of the vehicle 102.

In various embodiments, the one or more towing compliance checks 802 can include a check 802(2). In various aspects, the compliance component 212 can perform the check 802(2) by analyzing the gross trailer weight rating 704 and the current trailer weight 706. Specifically, the compliance component 212 can determine whether or not the trailer 104 is currently or presently overloaded, by comparing the gross trailer weight rating 704 to the current trailer weight 706. In response to the current trailer weight 706 being less than or equal to the gross trailer weight rating 704, the compliance component 212 can conclude that the trailer 104 is not currently or presently overloaded with cargo or freight. On the other hand, in response to the current trailer weight 706 being greater than the gross trailer weight rating 704, the compliance component 212 can conclude that the trailer 104 is currently or presently overloaded with cargo or freight. In such case, the compliance component 212 can: cause the towing compliance warning 804 to indicate, specify, or otherwise convey that the trailer 104 is overloaded and thus cannot be safely towed by the vehicle 102; or disable the vehicle 102 to prevent unsafe towing of the trailer 104.

In various embodiments, the one or more towing compliance checks 802 can include a check 802(3). In various aspects, the compliance component 212 can perform the check 802(3) by analyzing the gross vehicle weight rating 718 and the current vehicle weight 720. Specifically, the compliance component 212 can determine whether or not the vehicle 102 is currently or presently overloaded (e.g., by payload and tongue weight), by comparing the gross vehicle weight rating 718 to the current vehicle weight 720. In response to the current vehicle weight 720 being less than or equal to the gross vehicle weight rating 718, the compliance component 212 can conclude that the vehicle 102 is not currently or presently overloaded with payload or tongue weight. On the other hand, in response to the current vehicle weight 720 being greater than the gross vehicle weight rating 718, the compliance component 212 can conclude that the vehicle 102 is currently or presently overloaded with payload or tongue. In such case, the compliance component 212 can: cause the towing compliance warning 804 to indicate, specify, or otherwise convey that the vehicle 102 is overloaded and thus cannot safely tow the trailer 104; or disable the vehicle 102 to prevent unsafe towing of the trailer 104.

In various embodiments, the one or more towing compliance checks 802 can include a check 802(4). In various aspects, the compliance component 212 can perform the check 802(4) by analyzing the gross combined weight rating 716, the current trailer weight 706, and the current vehicle weight 720. Specifically, the compliance component 212 can determine whether or not the vehicle 102 and the trailer 104 collectively exceed the total amount of weight that the vehicle 102 is designed to handle, by comparing the gross combined weight rating 716 to the current vehicle weight 720 and the current trailer weight 706. In response to a sum of the current vehicle weight 720 and of the current trailer weight 706 being less than or equal to the gross combined weight rating 716, the compliance component 212 can conclude that the vehicle 102 and the trailer 104 do not collectively exceed the total amount of weight that the vehicle 102 is designed to handle. On the other hand, in response to the sum of the current vehicle weight 720 and the current trailer weight 706 being greater than the gross combined weight rating 716, the compliance component 212 can conclude that the vehicle 102 and the trailer 104 do collectively exceed the total amount of weight that the vehicle 102 is designed to handle. In such case, the compliance component 212 can: cause the towing compliance warning 804 to indicate, specify, or otherwise convey that the vehicle 102 and the trailer 104 are collectively too heavy for the vehicle 102 to safely tow; or disable the vehicle 102 to prevent unsafe towing of the trailer 104.

In various embodiments, the one or more towing compliance checks 802 can include a check 802(5). In various aspects, the compliance component 212 can perform the check 802(5) by analyzing the gross vehicle weight rating 718 and the gross trailer weight rating 704. Specifically, the compliance component 212 can determine whether or not towing of the trailer 104 by the vehicle 102 would trip the enhanced driver license trigger 510. Indeed, in some cases, the enhanced driver license trigger 510 can be a combined or total weight rating that is permitted to be driven or towed without an enhanced or higher-order driver license (e.g., without a CDL). In response to a sum of the gross trailer weight rating 704 and the gross vehicle weight rating 718 being less than or equal to the enhanced driver license trigger 510, the compliance component 212 can conclude that the driver can use the vehicle 102 to tow the trailer 104 without a CDL. On the other hand, in response to the sum of the gross trailer weight rating 704 and the gross vehicle weight rating 718 being greater than the enhanced driver license trigger 510, the compliance component 212 can conclude that the driver cannot use the vehicle 102 to tow the trailer 104 without a CDL. In such situation, the compliance component 212 can: cause the towing compliance warning 804 to indicate, specify, or otherwise convey that a CDL must first be obtained in order to use the vehicle 102 to tow the trailer 104; or disable the vehicle 102 to prevent unsafe towing of the trailer 104.

In various embodiments, the one or more towing compliance checks 802 can include a check 802(6). In various aspects, the compliance component 212 can perform the check 802(6) by analyzing the maximum safe trailer speed 708 and the current vehicle speed 722. Specifically, the compliance component 212 can determine whether or not the vehicle 102 is currently or presently traveling more quickly than the trailer 104 is capable of safely traveling, by comparing the maximum safe trailer speed 708 to the current vehicle speed 722. In response to the current vehicle speed 722 being less than or equal to the maximum safe trailer speed 708, the compliance component 212 can conclude that the vehicle 102 is not currently or presently traveling faster than the trailer 104 can safely travel. On the other hand, in response to the current vehicle speed 722 being greater than the maximum safe trailer speed 708, the compliance component 212 can conclude that the vehicle 102 is currently or presently traveling faster than the trailer 104 can safely travel. In such case, the compliance component 212 can cause the towing compliance warning 804 to indicate, specify, or otherwise convey that the vehicle 102 is traveling too fast for the trailer 104. In some of such cases, the compliance component 212 can cause or force the vehicle 102 to slow down to the maximum safe trailer speed 708, by activating any suitable brakes of the vehicle 102.

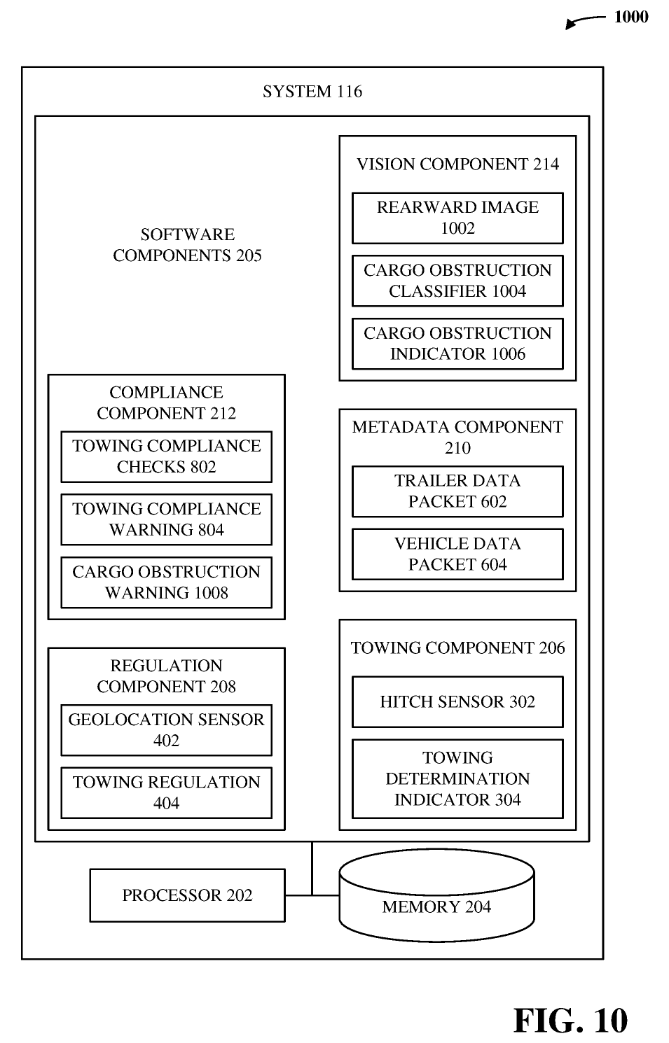

FIG. 10 illustrates a block diagram 1000 of the system 116 including a rearward image, a cargo obstruction classifier, and a cargo obstruction indicator that can facilitate towing-triggered visibility compliance indicators in accordance with one or more embodiments described herein.

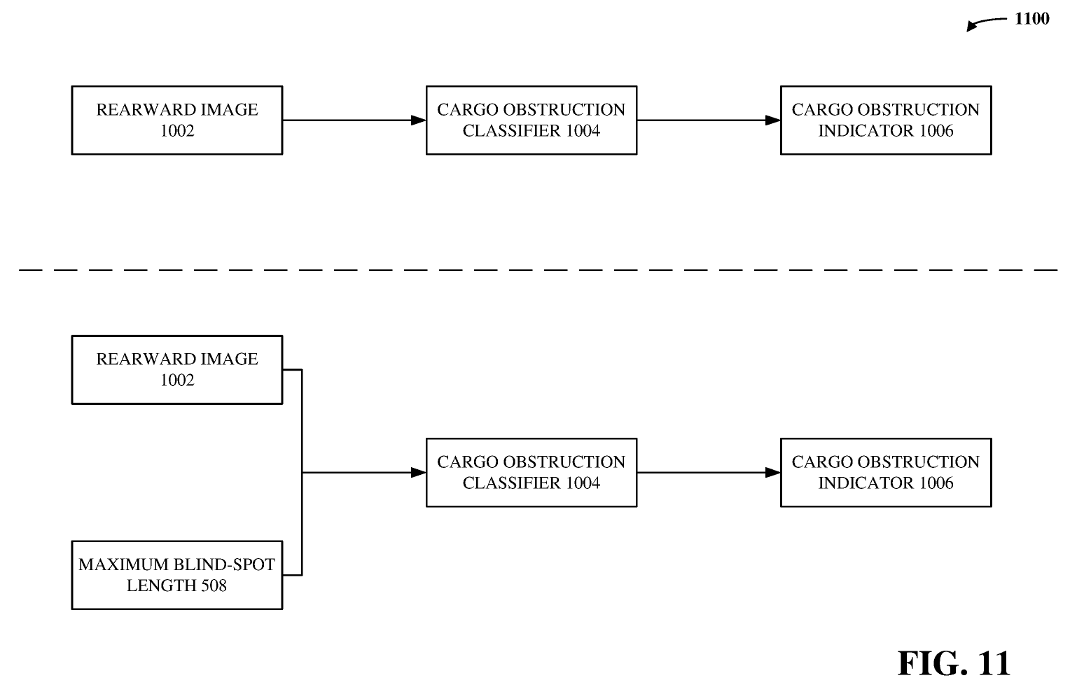

In various embodiments, if all of the one or more towing compliance checks 802 are satisfied by the trailer data packet 602 and by the vehicle data packet 604 (e.g., if none of the towing compliance checks 802 indicates an unsafe towing condition), this can be interpreted to mean that the vehicle 102 is theoretically capable of safely towing the trailer 104. In other words, this can be interpreted to mean that the vehicle 102, the trailer 104, and the side-view mirrors 108 are sized appropriately such that the length 114 of the blind-spot 112 is capable of being less than or equal to the maximum blind-spot length 508. Despite such capability, it is nevertheless possible that the length 114 of the blind-spot 112 is, in actuality, greater than the maximum blind-spot length 508. Such possibility can be due to cargo or freight being improperly stacked or improperly arranged on the trailer 104. For instance, if the trailer 104 is a flatbed or lowboy, it can be possible that cargo or freight was mistakenly loaded onto the trailer 104 so as to protrude excessively laterally outward (e.g., large planks of wood or metal might be sticking far leftward or far rightward off the surface of the trailer 104) such that the driver of the vehicle 102 does not have as much rearward visibility as is required by the towing regulation 404. As another instance, if the trailer 104 is an enclosed or boxed trailer, it can be possible that cargo or freight was impermissibly tied or lashed to an exterior leftward or rightward wall of the trailer 104. Just as above, such cargo or freight can be considered as protruding excessively laterally outward such that the driver of the vehicle 102 does not have as much rearward visibility as is required by the towing regulation 404. To address such possibilities, the vision component 214 can electronically generate a cargo obstruction indicator 1006, by executing a cargo obstruction classifier 1004 on a rearward image 1002 of the trailer 104. Non-limiting aspects are described with respect to FIG. 11.

FIG. 11 illustrates an example, non-limiting block diagram 1100 showing how the cargo obstruction indicator 1006 can be generated in accordance with one or more embodiments described herein.

In various embodiments, the vision component 214 can, in response to all of the one or more towing compliance checks 802 being satisfied (e.g., in response to none of the one or more towing compliance checks 802 being tripped, being failed, or otherwise flagging an unsafe towing/driving condition), electronically capture, electronically record, or otherwise electronically obtain the rearward image 1002. In various aspects, the rearward image 1002 can be any suitable two-dimensional pixel array that is captured by any suitable external, rearward-facing camera of the vehicle 102. As a non-limiting example, the rearward image 1002 can be captured by any suitable camera that is mounted to a rear bumper of the vehicle 102. As another non-limiting example, the rearward image 1002 can be captured by any suitable camera that is mounted to a rear-facing surface of the side-view mirrors 108. In any case, the rearward image 1002 can visually depict or illustrate the trailer 104 from the rear-facing perspective of the vehicle 102.

Now, in various embodiments, the vision component 214 can electronically store, electronically maintain, electronically control, or otherwise electronically access the cargo obstruction classifier 1004. In various aspects, the cargo obstruction classifier 1004 can exhibit any suitable type, style, construction, or design of internal architecture. For instance, the cargo obstruction classifier 1004 can exhibit any suitable deep learning internal architecture.

Indeed, in various cases, the cargo obstruction classifier 1004 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

However, this is merely a non-limiting example. In various embodiments, the cargo obstruction classifier 1004 can exhibit any other suitable type of artificial intelligence architecture. As a non-limiting example, the cargo obstruction classifier 1004 can exhibit any suitable type of support vector machine architecture. As another non-limiting example, the cargo obstruction classifier 1004 can exhibit any suitable type of naïve Bayes architecture. As yet another non-limiting example, the cargo obstruction classifier 1004 can exhibit any suitable type of linear regression architecture. As still another non-limiting example, the cargo obstruction classifier 1004 can exhibit any suitable type of logistic regression architecture. As even another non-limiting example, the cargo obstruction classifier 1004 can exhibit any suitable type of decision tree or random forest architecture. As another non-limiting example, the cargo obstruction classifier 1004 can exhibit any suitable combination of any of the above-mentioned architectures.

Regardless of the specific internal architecture (e.g., the specific numbers, types, or organizations of layers) that is implemented within the cargo obstruction classifier 1004, the cargo obstruction classifier 1004 can be configured as an image classifier that determines, in response to being executed on inputted images of trailers, whether or not the cargo or freight on those trailers is protruding too far sideways (or, in some cases, too far upwards) so as to impermissibly impede or obstruct visibility behind those trailers. Accordingly, the vision component 214 can, in various cases, electronically execute the cargo obstruction classifier 1004 on the rearward image 1002, and such execution can cause the cargo obstruction classifier 1004 to produce the cargo obstruction indicator 1006.

More specifically, suppose that the cargo obstruction classifier 1004 has a deep learning internal architecture. In some of such cases, the vision component 214 can feed the rearward image 1002 to the input layer of the cargo obstruction classifier 1004, the rearward image 1002 can complete a forward pass through the one or more hidden layers of the cargo obstruction classifier 1004, and the output layer of the cargo obstruction classifier 1004 can calculate or compute the cargo obstruction indicator 1006 based on whatever activation maps or features maps are produced by the one or more hidden layers during that forward pass. In some situations, however, the cargo obstruction classifier 1004 can be explicitly conditioned on the maximum blind-spot length 508 (e.g., such that the maximum blind-spot length 508 is an explicit auxiliary input of the cargo obstruction classifier 1004). In such cases, the vision component 214 can concatenate the rearward image 1002 and the maximum blind-spot length 508 together, that concatenation can be routed to the input layer of the cargo obstruction classifier 1004, that concatenation can complete a forward pass through the one or more hidden layers of the cargo obstruction classifier 1004, and the output layer of the cargo obstruction classifier 1004 can compute or calculate the cargo obstruction indicator 1006 based on whatever activation maps or features maps are produced by the one or more hidden layers during that forward pass.

In any case, the cargo obstruction indicator 1006 can be considered as a classification label that binarily or dichotomously indicates whether or not the cargo or freight that is depicted within the rearward image 1002 as being loaded on the trailer 104 protrudes laterally so much as to create a rear blind-spot whose length exceeds the maximum blind-spot length 508. In other words, the cargo obstruction indicator 1006 can be one or more scalars, one or more vectors, one or more matrices, one or more tensors, one or more character strings, or any suitable combination thereof that indicates either: whatever cargo or freight that is illustrated in the rearward image 1002 does not visually appear to be sticking so far out to the sides of the trailer 104 so as to create a blind-spot behind the trailer 104 that is larger than the maximum blind-spot length 508; or whatever cargo or freight that is illustrated in the rearward image 1002 does visually appear to be sticking so far out to the sides of the trailer 104 so as to create a blind-spot behind the trailer 104 that is larger than the maximum blind-spot length 508.

Note that the cargo obstruction indicator 1006 can be accurately or confidently generated in situations where the cargo obstruction classifier 1004 is not configured to receive the maximum blind-spot length 508 as a supplemental or complementary input argument in conjunction with the rearward image 1002. However, such accuracy or confidence, as well as a generalizability of the cargo obstruction classifier 1004, can be increased or enhanced by configurating the cargo obstruction classifier 1004 to receive the maximum blind-spot length 508 as a supplemental or complementary input argument in conjunction with the rearward image 1002. Indeed, the maximum blind-spot length 508 can be considered as rich context which can assist the cargo obstruction classifier 1004 in making more informed visibility classification decisions for different geolocations (e.g., different geolocations can implement different towing regulations and thus different maximum blind-spot sizes).

Referring back to FIG. 10, the compliance component 212 can perform any suitable electronic actions based on the cargo obstruction indicator 1006. Indeed, in response to the cargo obstruction indicator 1006 specifying that the cargo or freight of the trailer 104 does not visually appear to be protruding sideways so much as to block the rearward visibility of the vehicle 102 in violation of the towing regulation 404, the compliance component 212 can permit the vehicle 102 to tow the trailer 104 (e.g., at such point, neither the compliance component 212 nor the vision component 214 can have found anything wrong or unsafe about the vehicle 102 towing the trailer 104, and the compliance component 212 can even render on the electronic display a notification stating such). However, in response to the cargo obstruction indicator 1006 specifying that the cargo or freight of the trailer 104 does visually appear to be protruding sideways so much as to block the rearward visibility of the vehicle 102 in violation of the towing regulation 404, the compliance component 212 can render on the electronic display or screen of the vehicle 102 a cargo obstruction warning 1008, which can be any suitable electronic message or notification that indicates or relays that, although the vehicle 102 is capable of safely towing the trailer 104, the vehicle 102 cannot currently or presently do so due to the cargo or freight protruding too far over the sides of the trailer 104. In some of such cases, the cargo obstruction warning 1008 can recommend that the cargo or freight be repositioned or re-arranged on the trailer 104, so as to not stick out over the sides of the trailer 104. In others of such cases, the compliance component 212 can electronically prevent the vehicle 102 from towing the trailer 104 (e.g., by activating any suitable brakes of the vehicle 102, by deactivating any suitable engine or motor of the vehicle 102).

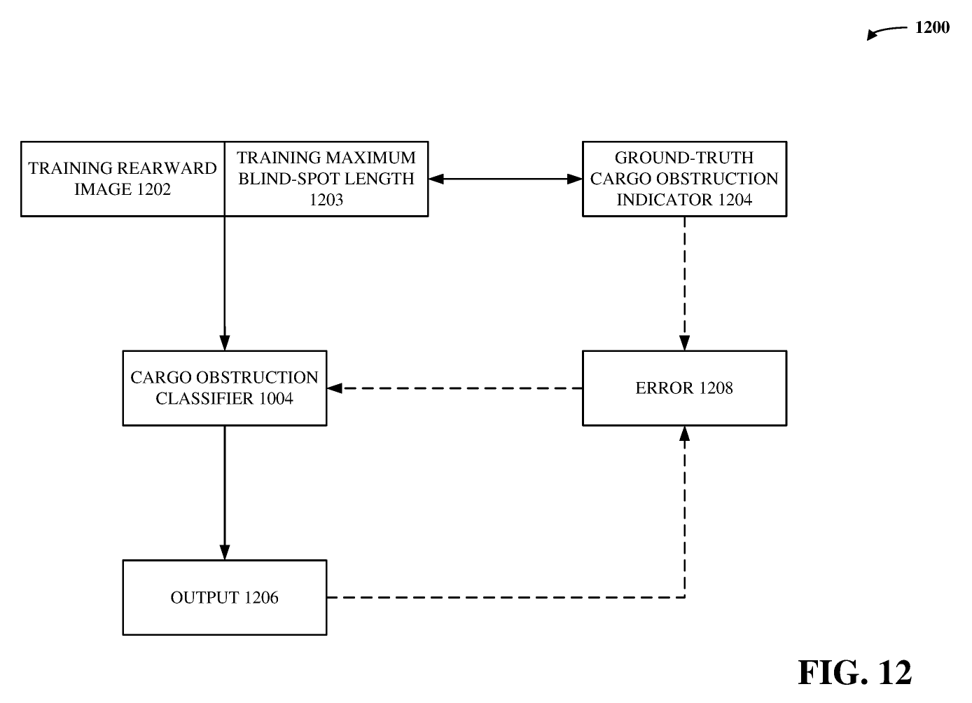

In order for the cargo obstruction indicator 1006 to be correct or reliable, the cargo obstruction classifier 1004 should first be trained. Non-limiting aspects of such training are described with respect to FIG. 12.

FIG. 12 illustrates an example, non-limiting block diagram 1200 showing how the cargo obstruction classifier 1004 can be trained in accordance with one or more embodiments described herein.

In various aspects, prior to beginning training, the trainable internal parameters (e.g., convolutional kernels, weight matrices, bias values) of the cargo obstruction classifier 1004 can be initialized in any suitable fashion (e.g., via random initialization) by the vision component 214.

In various embodiments, there can be any suitable training rearward image 1202, which may or may not be accompanied by a training maximum blind-spot length 1203 depending upon how the cargo obstruction classifier 1004 is configured, and a corresponding ground-truth cargo obstruction indicator 1204. In various aspects, the training rearward image 1202 can be any suitable image having the same format, size, or dimensionality as the rearward image 1002 and that depicts or illustrates any suitable trailer (e.g., not necessarily the trailer 104) from any suitable rear-facing perspective. In various instances, the training maximum blind-spot length 1203 can have the same format, size, or dimensionality as the maximum blind-spot length 508 and can indicate or specify the maximum permissible length of a blind-spot that is applicable to whatever trailer is depicted or illustrated in the training rearward image 1202 (e.g., might be different from the maximum blind-spot length 508). In various cases, the ground-truth cargo obstruction indicator 1204 can have the same format, size, or dimensionality as the cargo obstruction indicator 1006 and can be deemed or known to correctly or accurately indicate or specify whether or not the training rearward image 1202 depicts or illustrates its trailer with excessively laterally protruding cargo or freight such that the training maximum blind-spot length 1203 is exceeded, violated, or not satisfied.

In various aspects, the vision component 214 can cause the cargo obstruction classifier 1004 to be executed on the training rearward image 1202 (and on the training maximum blind-spot length 1203, as appropriate), thereby causing the cargo obstruction classifier 1004 to produce an output 1206. As a non-limiting example, in situations where the cargo obstruction classifier 1004 is configured to receive maximum blind-spot length as a supplemental input, the training rearward image 1202 and the training maximum blind-spot length 1203 can be concatenated together, such concatenation can be fed or routed to the input layer of the cargo obstruction classifier 1004, such concatenation can complete a forward pass through the one or more hidden layers of the cargo obstruction classifier 1004, and the output layer of the cargo obstruction classifier 1004 can compute the output 1206 based on activation maps or feature maps provided by the one or more hidden layers during such forward pass. As another non-limiting example, in situations where the cargo obstruction classifier 1004 is not configured to receive maximum blind-spot length as a supplemental input, the training rearward image 1202 can be fed or routed by itself to the input layer of the cargo obstruction classifier 1004, the training rearward image 1202 can complete a forward pass through the one or more hidden layers of the cargo obstruction classifier 1004, and the output layer of the cargo obstruction classifier 1004 can compute the output 1206 based on activation maps or feature maps provided by the one or more hidden layers during such forward pass.

Note that the format, size, or dimensionality of the output 1206 can be dictated by the number, arrangement, sizes, or other characteristics of the neurons, convolutional kernels, attention blocks, or other internal parameters of the output layer (or of any other layers) of the cargo obstruction classifier 1004. Accordingly, the output 1206 can be forced to have any desired format, size, or dimensionality, by adding, removing, or otherwise adjusting characteristics of the output layer (or of any other layers) of the cargo obstruction classifier 1004.

In various aspects, the output 1206 can be forced to have the same format, size, or dimensionality as the ground-truth cargo obstruction indicator 1204. Thus, the output 1206 can be considered as the predicted or inferred cargo obstruction indicator or classification label that the cargo obstruction classifier 1004 has created for the training rearward image 1202. In contrast, the ground-truth cargo obstruction indicator 1204 can be considered as whatever correct or accurate classification label that is known or deemed to correspond to the training rearward image 1202. Note that, if the cargo obstruction classifier 1004 has so far undergone no or little training, then the output 1206 can be highly inaccurate. In other words, the output 1206 can be very different from the ground-truth cargo obstruction indicator 1204.

In various aspects, an error 1208 (e.g., mean absolute error, mean squared error, cross-entropy error) between the output 1206 and the ground-truth cargo obstruction indicator 1204 can be computed by the vision component 214. In various instances, the vision component 214 can incrementally update the trainable internal parameters of the cargo obstruction classifier 1004 via backpropagation (e.g., stochastic gradient descent) based on the error 1208.

In various cases, such execution-and-update procedure can be repeated for any suitable number of training rearward images. This can ultimately cause the trainable internal parameters of the cargo obstruction classifier 1004 to become iteratively optimized for accurately recognizing whether or not trailer cargo is depicted as protruding excessively sideways in inputted trailer images. In various aspects, any suitable training batch sizes, any suitable error/loss functions, or any suitable training termination criteria can be utilized during such training.

Although the herein disclosure mainly describes the cargo obstruction classifier 1004 as being trained in supervised fashion, this is a mere non-limiting example for ease of explanation and illustration. In various embodiments, any other suitable training paradigms can be used to train the cargo obstruction classifier 1004, such as unsupervised training, semi-supervised training, or reinforcement learning, any of which may be federated or unfederated.

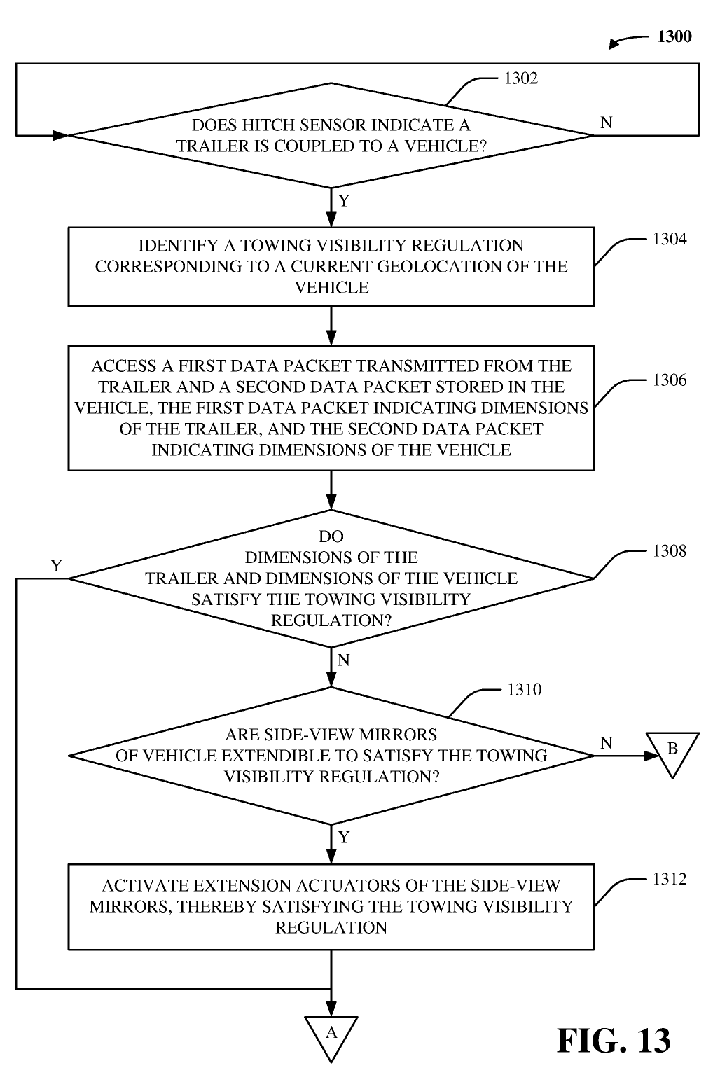

FIGS. 13-15 illustrate flow diagrams of example, non-limiting computer-implemented methods 1300 and 1500 that can facilitate towing-triggered visibility compliance indicators in accordance with one or more embodiments described herein. In various cases, the system 116 can facilitate the computer-implemented method 1300 or the computer-implemented method 1500.

First, consider FIG. 13. In various embodiments, act 1302 can include determining, by a device (e.g., via 206) operatively coupled to a processor (e.g., 202), whether a hitch sensor (e.g., 302) indicates that a trailer (e.g., 104) is coupled to a vehicle (e.g., 102). If not, the computer-implemented method 1300 can proceed back to act 1302. If so, the computer-implemented method 1300 can proceed to act 1304.

In various aspects, act 1304 can include identifying, by the device (e.g., via 208), a towing visibility regulation (e.g., 404) corresponding to a current geolocation of the vehicle.

In various instances, act 1306 can include accessing, by the device (e.g., via 210), a first data packet (e.g., 602) transmitted from the trailer and a second data packet (e.g., 604) stored in the vehicle, where the first data packet can indicate dimensions of the trailer (e.g., 702), and where the second data packet can indicate dimensions of the vehicle or of accessories thereof (e.g., 710, 712, 714).

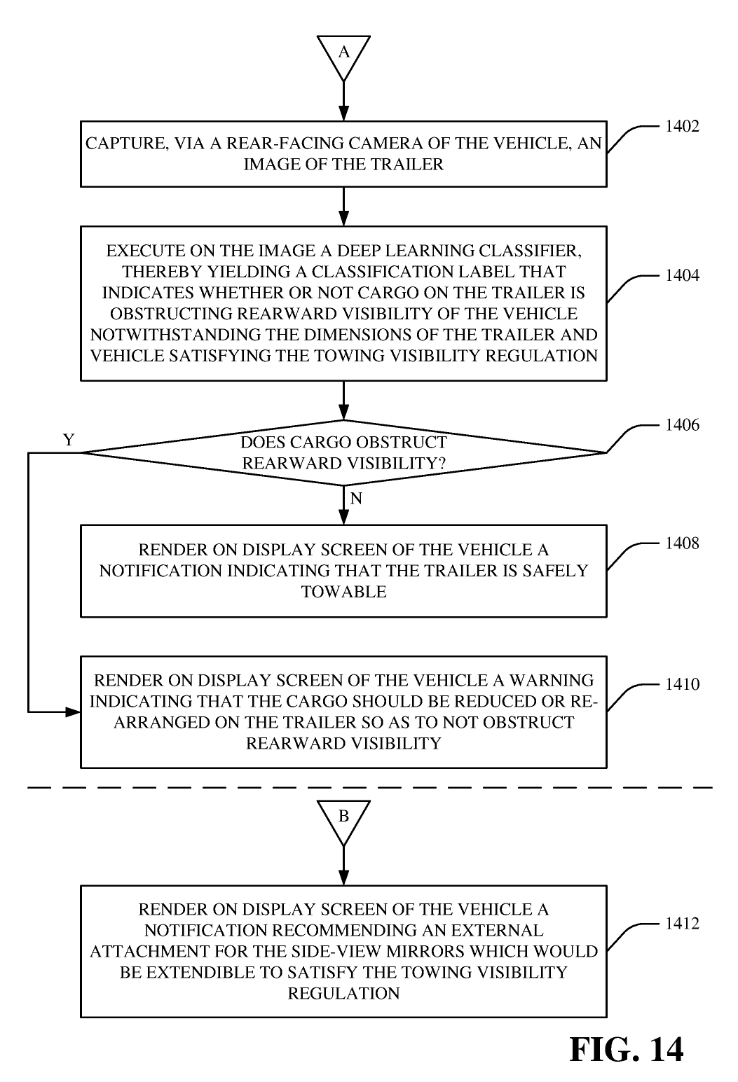

In various cases, act 1308 can include determining, by the device (e.g., via 212), whether the dimensions of the trailer and the dimensions of the vehicle (or accessories thereof) satisfy the towing visibility regulation. If not, the computer-implemented method 1300 can proceed to act 1310. If so (e.g., if the check 802(1) is successfully passed), the computer-implemented method 1300 can proceed to act 1402 shown in FIG. 14.

In various aspects, act 1310 can include determining, by the device (e.g., via 212), whether side-view mirrors (e.g., 108) of the vehicle are extendible so as to satisfy the towing visibility regulation. If not, the computer-implemented method 1300 can proceed to act 1412 of FIG. 14. If so, the computer-implemented method 1300 can proceed to act 1312.

In various aspects, act 1312 can include activating, by the device (e.g., via 212), extension actuators of the side-view mirrors, thereby satisfying the towing visibility regulation. The computer-implemented method 1300 can then proceed to act 1402 of FIG. 14.

Now, consider FIG. 14. In various embodiments, act 1402 can include capturing, by the device (e.g., via 214) and via a rear-facing camera of the vehicle, an image (e.g., 1002) of the trailer.

In various aspects, act 1404 can include executing, by the device (e.g., via 214) and on the image, a deep learning classifier (e.g., 1004), thereby yielding a classification label (e.g., 1006) that indicates whether or not cargo on the trailer is obstructing a rearward visibility of the vehicle notwithstanding the dimensions of the trailer and of the vehicle satisfying the towing regulation.

In various instances, act 1406 can include determining, by the device (e.g., via 214), whether the cargo obstructs the rearward visibility. If not, the computer-implemented method 1300 can proceed to act 1408. If so, the computer-implemented method 1300 can proceed to act 1410.

In various cases, act 1408 can include rendering, by the device (e.g., via 212) and on a display screen of the vehicle, a notification indicating that the trailer is safely towable by the vehicle.

In various aspects, act 1410 can include rendering, by the device (e.g., via 212) and on the display screen, a warning (e.g., 1008) indicating that the cargo should be reduced or re-arranged on the trailer so as to not obstruct the rearward visibility.

In various instances, act 1412 can include rendering, by the device (e.g., via 212) and on the display screen, a notification (e.g., 804) recommending an external attachment for the side-view mirrors which would be extendible to satisfy the towing visibility regulation.

Note that acts 1308, 1310, 1312, and 1412 can collectively be considered as making up at least some portions of the check 802(1).

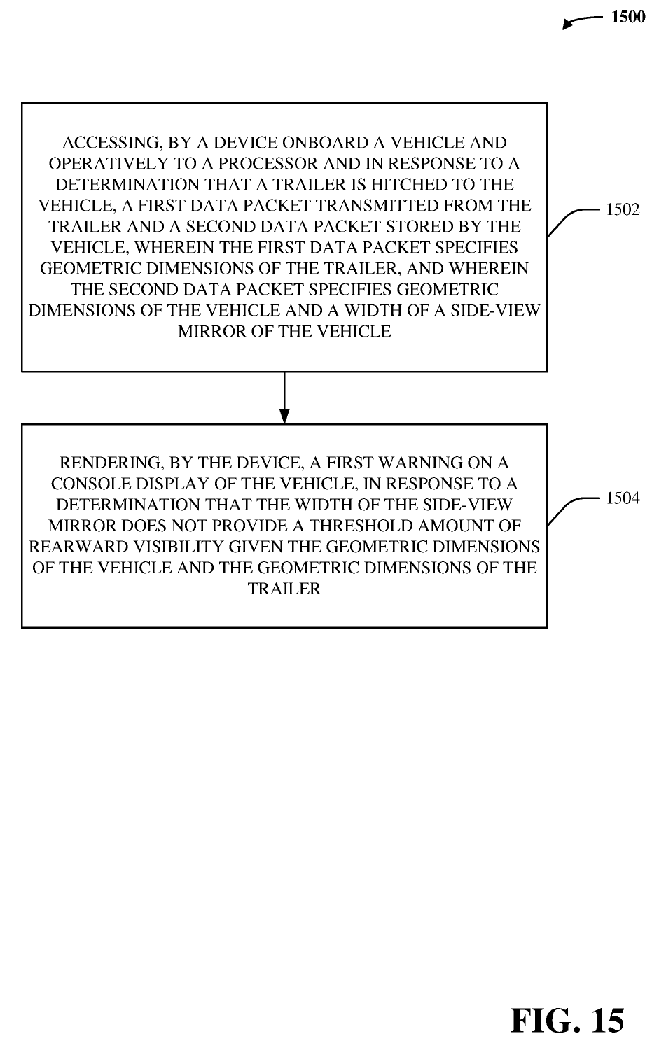

Next, consider FIG. 15.

In various embodiments, act 1502 can include accessing, by a device (e.g., via 210) onboard a vehicle (e.g., 102) and operatively coupled to a processor (e.g., 202) and in response to a determination (e.g., 304) that a trailer (e.g., 104) is hitched to the vehicle, a first data packet (e.g., 602) transmitted from the trailer and a second data packet (e.g., 604) stored by the vehicle, wherein the first data packet specifies geometric dimensions (e.g., 702) of the trailer, and wherein the second data packet specifies geometric dimensions (e.g., 710) of the vehicle and a width (e.g., 712) of a side-view mirror (e.g., 108) of the vehicle.

In various aspects, act 1504 can include rendering, by the device (e.g., via 212), a first warning (e.g., 804) on a console display of the vehicle, in response to a determination that the width of the side-view mirror does not provide a threshold amount of rearward visibility (e.g., 508) given the geometric dimensions of the vehicle and the geometric dimensions of the trailer (e.g., such determination can be made during 802(1)).

Although not explicitly shown in FIG. 15, the threshold amount of rearward visibility can be specified by a towing visibility regulation (e.g., 404), and the computer-implemented method 1500 can include: identifying, by the device (e.g., via 208), the towing visibility regulation, based on a current geographical location of the vehicle as measured by a global positioning sensor (e.g., 402) of the vehicle.

Although not explicitly shown in FIG. 15, the computer-implemented method 1500 can include: determining, by the device (e.g., via 206), that the trailer is hitched to the vehicle, based on a sensor (e.g., 302) monitoring a hitch of the vehicle.

Although not explicitly shown in FIG. 15, the side-view mirror can be: non-extendable, and the width can be fixed; or extendable, and the width can be a maximum reachable width of the side-view mirror. In such cases, the first warning can identify a side-view mirror attachment that, if equipped to the vehicle, would provide the threshold amount of rearward visibility, the side-view mirror attachment being made up of an auxiliary mirror or an electronic screen that renders a video feed recorded by a bumper-mounted camera of the trailer.

Although not explicitly shown in FIG. 15, the side-view mirror or an attachment thereof can be extendible, the width can be a current width of the side-view mirror or the attachment thereof that is less than a maximum reachable width of the side-view mirror or the attachment thereof, and the computer-implemented method 1500 can include: activating, by the device (e.g., via 212) and in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

Although not explicitly shown in FIG. 15, the computer-implemented method 1500 can include: recording, by the device (e.g., via 214), via a rear-facing camera of the vehicle, and in response to a determination that the width of the side-view mirror provides the threshold amount of rearward visibility, at least one image (e.g., 1002) depicting the trailer and a cargo of the trailer; and determining, by the device (e.g., via 214) and via execution of a deep learning neural network (e.g., 1004) on the at least one image, whether the cargo obstructs the threshold amount of rearward visibility.

Although not explicitly shown in FIG. 15, the computer-implemented method 1500 can include: rendering, by the device (e.g., via 212) and in response to a determination that the cargo obstructs the threshold amount of rearward visibility, a second warning (e.g., 1008) on the console display, the second warning recommending that the cargo should be re-arranged so as to not obstruct the threshold amount of rearward visibility (e.g., should be re-arranged so as to not excessively overhang the lateral sides of the trailer).

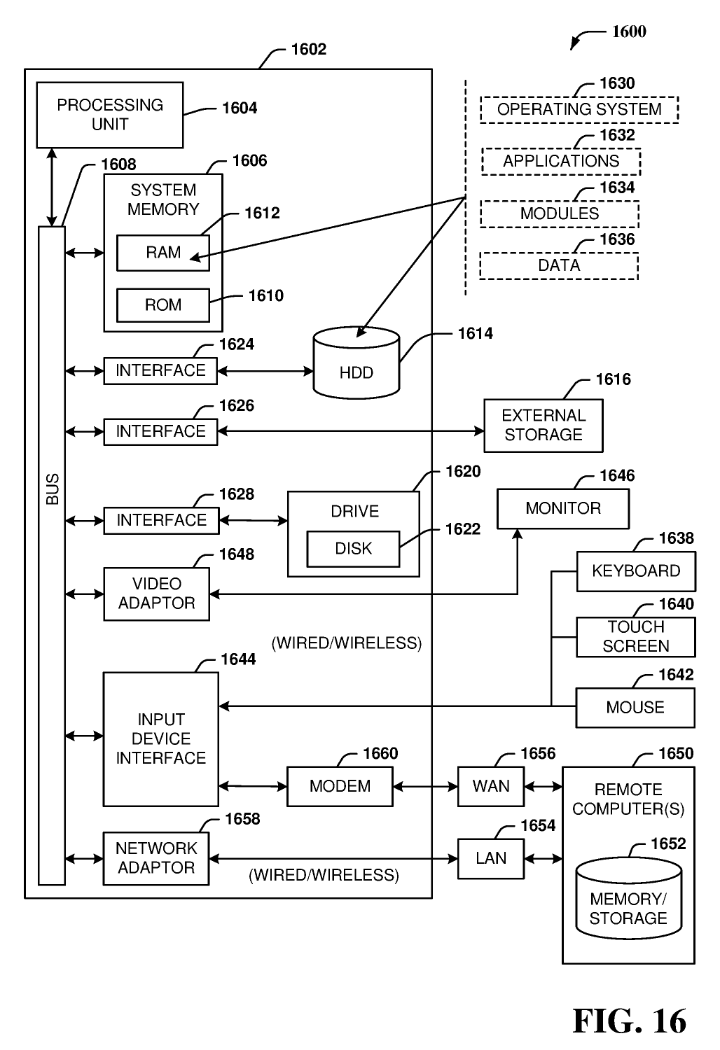

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and a drive 1620, e.g., such as a solid state drive, an optical disk drive, which can read or write from a disk 1622, such as a CD-ROM disc, a DVD, a BD, etc. Alternatively, where a solid state drive is involved, disk 1622 would not be included, unless separate. While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and drive 1620 can be connected to the system bus 1608 by an HDD interface 1624, an external storage interface 1626 and a drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above, such as but not limited to a network virtual machine providing one or more aspects of storage or processing of information. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

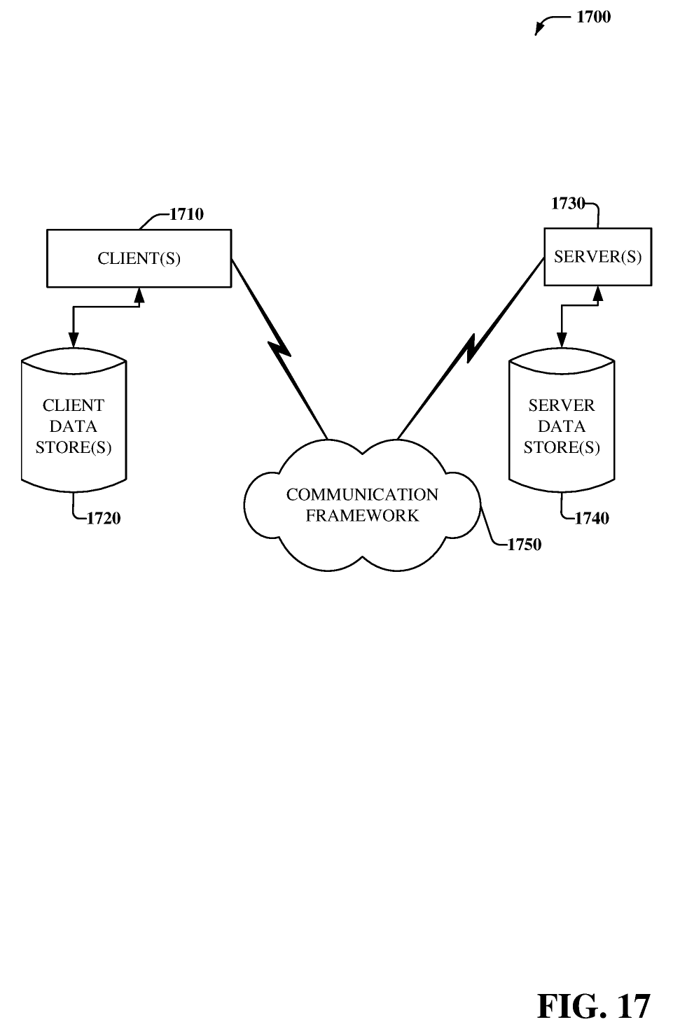

FIG. 17 is a schematic block diagram of a sample computing environment 1700 with which the disclosed subject matter can interact. The sample computing environment 1700 includes one or more client(s) 1710. The client(s) 1710 can be hardware or software (e.g., threads, processes, computing devices). The sample computing environment 1700 also includes one or more server(s) 1730. The server(s) 1730 can also be hardware or software (e.g., threads, processes, computing devices). The servers 1730 can house threads to perform transformations by employing one or more embodiments as described herein, for example. One possible communication between a client 1710 and a server 1730 can be in the form of a data packet adapted to be transmitted between two or more computer processes. The sample computing environment 1700 includes a communication framework 1750 that can be employed to facilitate communications between the client(s) 1710 and the server(s) 1730. The client(s) 1710 are operably connected to one or more client data store(s) 1720 that can be employed to store information local to the client(s) 1710. Similarly, the server(s) 1730 are operably connected to one or more server data store(s) 1740 that can be employed to store information local to the servers 1730.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

EXAMPLE 1: A system onboard a vehicle can comprise: a processor that executes computer-executable components stored in a non-transitory computer-readable memory, wherein the computer-executable components can comprise: a metadata component that can access, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and a compliance component that can render a first warning on a console display of the vehicle, in response to a determination that the width of the side-view mirror does not provide a threshold amount of rearward visibility given the geometric dimensions of the vehicle and the geometric dimensions of the trailer.

EXAMPLE 2: The system of any preceding example can be implemented, wherein: the threshold amount of rearward visibility can be specified by a towing visibility regulation; the computer-executable components can comprise a regulation component that can identify the towing visibility regulation, based on a current geographical location of the vehicle as measured by a global positioning sensor of the vehicle; the computer-executable components can comprise a towing component that can determine that the trailer is hitched to the vehicle, based on a sensor monitoring a hitch of the vehicle; the side-view mirror can be: non-extendable, and the width is fixed; or extendable, and the width is a maximum reachable width of the side-view mirror; the first warning can identify a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer; the side-view mirror or an attachment thereof can be extendible, wherein the width is a current width of the side-view mirror or the attachment thereof that is less than a maximum reachable width of the side-view mirror or the attachment thereof, and wherein the compliance component activates, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width; the computer-executable components can comprise a vision component that records, via a rear-facing camera of the vehicle and in response to a determination that the width of the side-view mirror provides the threshold amount of rearward visibility, at least one image depicting the trailer and a cargo of the trailer, wherein the vision component determines, via execution of a deep learning neural network on the at least one image, whether the cargo obstructs the threshold amount of rearward visibility; and the compliance component can render, in response to a determination that the cargo obstructs the threshold amount of rearward visibility, a second warning on the console display, the second warning recommending that the cargo should be re-arranged so as to not obstruct the threshold amount of rearward visibility.

EXAMPLE 3: The system of any preceding example can be implemented, wherein the threshold amount of rearward visibility can be specified by a towing visibility regulation, and wherein the computer-executable components can comprise: a regulation component that can identify the towing visibility regulation, based on a current geographical location of the vehicle as measured by a global positioning sensor of the vehicle.

EXAMPLE 4: The system of any preceding example can be implemented, wherein the computer-executable components can comprise: a towing component that can determine that the trailer is hitched to the vehicle, based on a sensor monitoring a hitch of the vehicle.

EXAMPLE 5: The system of any preceding example can be implemented, wherein: the side-view mirror can be: non-extendable, and the width can be fixed; or extendable, and the width can be a maximum reachable width of the side-view mirror; and the first warning can identify a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

EXAMPLE 6: The system of any preceding example can be implemented, wherein the side-view mirror or an attachment thereof can be extendible, wherein the width can be a current width of the side-view mirror or the attachment thereof that is less than a maximum reachable width of the side-view mirror or the attachment thereof, and wherein the compliance component can activate, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

EXAMPLE 7: The system of any preceding example can be implemented, wherein the computer-executable components can comprise: a vision component that can record, via a rear-facing camera of the vehicle and in response to a determination that the width of the side-view mirror provides the threshold amount of rearward visibility, at least one image depicting the trailer and a cargo of the trailer, and wherein the compliance component can determine, via execution of a deep learning neural network on the at least one image, whether the cargo obstructs the threshold amount of rearward visibility.

EXAMPLE 8: The system of any preceding example can be implemented, wherein the compliance component can render, in response to a determination that the cargo obstructs the threshold amount of rearward visibility, a second warning on the console display, the second warning recommending that the cargo should be re-arranged so as to not obstruct the threshold amount of rearward visibility.

In various embodiments, any combination or combinations of examples 1-8 can be implemented.

EXAMPLE 9: A computer-implemented method performable by a device onboard a vehicle and operatively coupled to a processor can comprise: accessing, by the device and in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and rendering, by the device, a first warning on a console display of the vehicle, in response to a determination that the width of the side-view mirror does not provide a threshold amount of rearward visibility given the geometric dimensions of the vehicle and the geometric dimensions of the trailer.

EXAMPLE 10: The computer-implemented method of any preceding example can be implemented, wherein the threshold amount of rearward visibility can be specified by a towing visibility regulation, and further comprising: identifying, by the device, the towing visibility regulation, based on a current geographical location of the vehicle as measured by a global positioning sensor of the vehicle.

EXAMPLE 11: The computer-implemented method of any preceding example can be implemented, further comprising: determining, by the device, that the trailer is hitched to the vehicle, based on a sensor monitoring a hitch of the vehicle.

EXAMPLE 12: The computer-implemented method of any preceding example can be implemented, wherein: the side-view mirror can be: non-extendable, and the width can be fixed; or extendable, and the width can be a maximum reachable width of the side-view mirror; and the first warning can identify a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

EXAMPLE 13: The computer-implemented method of any preceding example can be implemented, wherein the side-view mirror or an attachment thereof can be extendible, wherein the width can be a current width of the side-view mirror or the attachment thereof that is less than a maximum reachable width of the side-view mirror or the attachment thereof, and further comprising: activating, by the device and in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

EXAMPLE 14: The computer-implemented method of any preceding example can be implemented, further comprising: recording, by the device and via a rear-facing camera of the vehicle and in response to a determination that the width of the side-view mirror provides the threshold amount of rearward visibility, at least one image depicting the trailer and a cargo of the trailer; and determining, by the device and via execution of a deep learning neural network on the at least one image, whether the cargo obstructs the threshold amount of rearward visibility.

EXAMPLE 15: The computer-implemented method of any preceding example can be implemented, further comprising: rendering, by the device and in response to a determination that the cargo obstructs the threshold amount of rearward visibility, a second warning on the console display, the second warning recommending that the cargo should be re-arranged so as to not obstruct the threshold amount of rearward visibility.

In various embodiments, any combination or combinations of examples 9-15 can be implemented.

EXAMPLE 16: A computer program product for facilitating towing-triggered visibility compliance indicators can comprise a non-transitory computer-readable memory having program instructions embodied therewith. In various aspects, the program instructions can be executable by a processor onboard a vehicle to cause the processor to: access, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and render a first warning on a console display of the vehicle, in response to a determination that the width of the side-view mirror does not provide a threshold amount of rearward visibility given the geometric dimensions of the vehicle and the geometric dimensions of the trailer.

EXAMPLE 17: The computer program product of any preceding example can be implemented, wherein the threshold amount of rearward visibility can be specified by a towing visibility regulation, and wherein the program instructions can be further executable to cause the processor to: identify the towing visibility regulation, based on a current geographical location of the vehicle as measured by a global positioning sensor of the vehicle.

EXAMPLE 18: The computer program product of any preceding example can be implemented, wherein the program instructions can be further executable to cause the processor to: determine that the trailer is hitched to the vehicle, based on a sensor monitoring a hitch of the vehicle.

EXAMPLE 19: The computer program product of any preceding example can be implemented, wherein: the side-view mirror can be: non-extendable, and the width can be fixed; or extendable, and the width can be a maximum reachable width of the side-view mirror; and the first warning can identify a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

EXAMPLE 20: The computer program product of any preceding example can be implemented, wherein the side-view mirror or an attachment thereof can be extendible, wherein the width can be a current width of the side-view mirror or the attachment thereof that is less than a maximum reachable width of the side-view mirror or the attachment thereof, and wherein the program instructions can be further executable to cause the processor to: activate, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

In various embodiments, any combination or combinations of examples 16-20 can be implemented.

In various embodiments, any combination or combinations of examples 1-20 can be implemented.

What is claimed is:

1. A system onboard a vehicle, comprising:
a processor that executes computer-executable components stored in a non-transitory computer-readable memory, wherein the computer-executable components comprise:
a metadata component that accesses, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and
a compliance component that renders a first warning on a console display of the vehicle, in response to a determination that the width of the side-view mirror does not provide a threshold amount of rearward visibility given the geometric dimensions of the vehicle and the geometric dimensions of the trailer.

2. The system of claim 1, wherein:
the threshold amount of rearward visibility is specified by a towing visibility regulation;
the computer-executable components comprise a regulation component that identifies the towing visibility regulation, based on a current geographical location of the vehicle as measured by a global positioning sensor of the vehicle;
the computer-executable components comprise a towing component that determines that the trailer is hitched to the vehicle, based on a sensor monitoring a hitch of the vehicle;
the side-view mirror is:
non-extendable, and the width is fixed; or
extendable, and the width is a maximum reachable width of the side-view mirror;
the first warning identifies a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer;
the side-view mirror or an attachment thereof is extendible, wherein the width is a current width of the side-view mirror or the attachment thereof that is less than a maximum reachable width of the side-view mirror or the attachment thereof, and wherein the compliance component activates, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width;
the computer-executable components comprise a vision component that records, via a rear-facing camera of the vehicle and in response to a determination that the width of the side-view mirror provides the threshold amount of rearward visibility, at least one image depicting the trailer and a cargo of the trailer, wherein the vision component determines, via execution of a deep learning neural network on the at least one image, whether the cargo obstructs the threshold amount of rearward visibility; and
the compliance component renders, in response to a determination that the cargo obstructs the threshold amount of rearward visibility, a second warning on the console display, the second warning recommending that the cargo should be re-arranged so as to not obstruct the threshold amount of rearward visibility.

3. The system of claim 1, wherein the threshold amount of rearward visibility is specified by a towing visibility regulation, and wherein the computer-executable components comprise:
a regulation component that identifies the towing visibility regulation, based on a current geographical location of the vehicle as measured by a global positioning sensor of the vehicle.

4. The system of claim 1, wherein the computer-executable components comprise:
a towing component that determines that the trailer is hitched to the vehicle, based on a sensor monitoring a hitch of the vehicle.

5. The system of claim 1, wherein:
the side-view mirror is:
non-extendable, and the width is fixed; or
extendable, and the width is a maximum reachable width of the side-view mirror; and
the first warning identifies a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

6. The system of claim 1, wherein the side-view mirror or an attachment thereof is extendible, wherein the width is a current width of the side-view mirror or the attachment thereof that is less than a maximum reachable width of the side-view mirror or the attachment thereof, and wherein the compliance component activates, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

7. The system of claim 1, wherein the computer-executable components comprise:
a vision component that records, via a rear-facing camera of the vehicle and in response to a determination that the width of the side-view mirror provides the threshold amount of rearward visibility, at least one image depicting the trailer and a cargo of the trailer, and wherein the vision component determines, via execution of a deep learning neural network on the at least one image, whether the cargo obstructs the threshold amount of rearward visibility.

8. The system of claim 7, wherein the compliance component renders, in response to a determination that the cargo obstructs the threshold amount of rearward visibility, a second warning on the console display, the second warning recommending that the cargo should be re-arranged so as to not obstruct the threshold amount of rearward visibility.

9. A computer-implemented method performable by a device onboard a vehicle and operatively coupled to a processor, comprising:
accessing, by the device and in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and
rendering, by the device, a first warning on a console display of the vehicle, in response to a determination that the width of the side-view mirror does not provide a threshold amount of rearward visibility given the geometric dimensions of the vehicle and the geometric dimensions of the trailer.

10. The computer-implemented method of claim 9, wherein the threshold amount of rearward visibility is specified by a towing visibility regulation, and further comprising:
identifying, by the device, the towing visibility regulation, based on a current geographical location of the vehicle as measured by a global positioning sensor of the vehicle.

11. The computer-implemented method of claim 9, further comprising:
determining, by the device, that the trailer is hitched to the vehicle, based on a sensor monitoring a hitch of the vehicle.

12. The computer-implemented method of claim 9, wherein:
the side-view mirror is:
non-extendable, and the width is fixed; or
extendable, and the width is a maximum reachable width of the side-view mirror; and
the first warning identifies a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

13. The computer-implemented method of claim 9, wherein the side-view mirror or an attachment thereof is extendible, wherein the width is a current width of the side-view mirror or the attachment thereof that is less than a maximum reachable width of the side-view mirror or the attachment thereof, and further comprising:
activating, by the device and in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.

14. The computer-implemented method of claim 9, further comprising:
recording, by the device and via a rear-facing camera of the vehicle and in response to a determination that the width of the side-view mirror provides the threshold amount of rearward visibility, at least one image depicting the trailer and a cargo of the trailer; and
determining, by the device and via execution of a deep learning neural network on the at least one image, whether the cargo obstructs the threshold amount of rearward visibility.

15. The computer-implemented method of claim 14, further comprising:
rendering, by the device and in response to a determination that the cargo obstructs the threshold amount of rearward visibility, a second warning on the console display, the second warning recommending that the cargo should be re-arranged so as to not obstruct the threshold amount of rearward visibility.

16. A computer program product for facilitating towing-triggered visibility compliance indicators, the computer program product comprising a non-transitory computer-readable memory having program instructions embodied therewith, the program instructions executable by a processor onboard a vehicle to cause the processor to:
access, in response to a determination that a trailer is hitched to the vehicle, a first data packet transmitted from the trailer and a second data packet stored by the vehicle, wherein the first data packet specifies geometric dimensions of the trailer, and wherein the second data packet specifies geometric dimensions of the vehicle and a width of a side-view mirror of the vehicle; and
render a first warning on a console display of the vehicle, in response to a determination that the width of the side-view mirror does not provide a threshold amount of rearward visibility given the geometric dimensions of the vehicle and the geometric dimensions of the trailer.

17. The computer program product of claim 16, wherein the threshold amount of rearward visibility is specified by a towing visibility regulation, and wherein the program instructions are further executable to cause the processor to:
identify the towing visibility regulation, based on a current geographical location of the vehicle as measured by a global positioning sensor of the vehicle.

18. The computer program product of claim 16, wherein the program instructions are further executable to cause the processor to:
determine that the trailer is hitched to the vehicle, based on a sensor monitoring a hitch of the vehicle.

19. The computer program product of claim 16, wherein:
the side-view mirror is:
non-extendable, and the width is fixed; or
extendable, and the width is a maximum reachable width of the side-view mirror; and
the first warning identifies a side-view mirror attachment that, if equipped to the vehicle, would provide the threshold amount of rearward visibility, the side-view mirror attachment comprising an auxiliary mirror or an electronic screen that renders a video feed recorded by a bumper-mounted camera of the trailer.

20. The computer program product of claim 16, wherein the side-view mirror or an attachment thereof is extendible, wherein the width is a current width of the side-view mirror or the attachment thereof that is less than a maximum reachable width of the side-view mirror or the attachment thereof, and wherein the program instructions are further executable to cause the processor to:
activate, in response to determining that a new width which is greater than the width and less than or equal to the maximum reachable width would provide the threshold amount of rearward visibility, a motorized actuator of the side-view mirror or the attachment thereof, thereby causing the side-view mirror or the attachment thereof to extend from the width to the new width.
